(19) United States
(12) Patent Application Publication
(10) Pub. No.: US 2008/0057228 A1
(43) Pub. Date: Mar. 6, 2008

(54) Anti-glare film and liquid crystal display apparatus

(75) Inventors: Wataru Horie, Osaka (JP); Toshiharu Hirai, Kitakyusyu-shi (JP); Masayuki Matsuda, Kitakyusyu-shi (JP); Mitsuaki Kumazawa, Kitakyusyu-shi (JP); Hiroshi Takahashi, Himeji-shi (JP); Shinji Kikuchi, Himeji-shi (JP)

Correspondence Address: BIRCH STEWART KOLASCH & BIRCH, PO BOX 747, FALLS CHURCH, VA, 22040-0747, US

(73) Assignees: Sharp Corporation; Catalysts & Chemicals Industries Co., Ltd.; DAICEL CHEMICAL INDUSTRIES, LTD.

(21) Appl. No.: 11/896,262

(22) Filed: Aug. 30, 2007

(30) Foreign Application Priority Data
Aug. 31, 2006 (JP) 236714/2006

(51) Int. Cl. B32B 3/00; B32B 3/26; B32B 7/02; C09K 19/02

(52) U.S. Cl. 428/1.32; 428/172; 428/212; 428/313.9

(57) ABSTRACT

An anti-glare film comprises an anti-glare layer, and a low-refraction-index layer formed on at least one surface thereof and comprising a low-refraction-index resin and a hollow silica particle. The film has an internal haze of 0 to 1%, a haze of 5 to 6.5%, a transmitted image clarity of 20 to 30%, and a reflected light of the film has a* of 0.5 to 1.3 and b* of −2.3 to −0.5. The particle may have a mean particle diameter of about 50 to 70 nm and a refraction index of about 1.2 to 1.25. The film may have an uneven surface, and the average inclination angle of the surface may be about 0.7 to 1°. The anti-glare layer may comprise plural polymers and have a domain formed by a phase separation, and a difference in refraction index between the polymers may be about 0 to 0.04.

### FIELD OF THE INVENTION

The present invention relates to an anti-glare film used in various liquid crystal displays for computers, word processors, televisions and others and a display apparatus comprising (or equipped with) the anti-glare film.

### BACKGROUND OF THE INVENTION

In these days, liquid crystal displays have made a remarkable progress as a display apparatus for television (TV) application or movie display application, and the liquid crystal displays rapidly become popular. For example, the development of a liquid crystal material having a high-speed responsiveness or the improvement of a drive system such as overdrive has overcome movie display that has been a drawback of the liquid crystal for a long time, and the innovation of industrial technology coping or dealing with the increase in display size has progressed.

In these displays, a treatment for inhibiting reflection of an exterior light is usually subjected to a surface thereof in application in which image quality is considered as important (e.g., a television and a monitor) and application of using the displays in the open air with a strong exterior light (e.g., a video camera). One of the means is an anti-glare treatment. For example, a surface of a liquid crystal display is usually subjected to the anti-glare treatment. By the anti-glare treatment, a finely uneven structure is formed on the surface of the display so as to have effects on scattering of a reflected light from the surface and blurring of a reflected image on the surface. Therefore, contrary to a clear anti-reflection film, in the anti-glare layer, the reflected light hardly tends to interface with a projected image (or screen image) on the display since shapes of viewer and background are not reflected.

For example, Japanese Patent Application Laid-Open No. 337734/1999 (JP-11-337734A (claims 1, 4 and 8, and paragraph number [0001])) discloses an antiglare-treated layer having an uneven structure on a surface thereof, that is used as a surface-treated layer formed on a surface of a polarizing film which is preferable for a material of a liquid crystal cell. This document mentions that the antiglare-treated layer is formed by coating (e.g., spin-coating) a resin solution in which fine particles having a high refraction index are dispersed, or by coating (e.g., spin-coating) only an acrylic resin and then directly imparting irregularity to the surface mechanically or chemically.

Japanese Patent Application Laid-Open No. 215307/2001 (JP-2001-215307A (Claim 1, and paragraph number [0012])) discloses an anti-glare layer containing a transparent fine particle having a mean particle diameter of 15 μm in a coat layer whose thickness is not less than twice of the mean particle diameter. The anti-glare layer has a surface having a finely uneven structure through unevenly distributing the transparent fine particles in one side of the coat layer which is in touch with air.

However, it is difficult to make the both refraction indexes of the fine particle and of the resin uniform. As a result, such an anti-glare layer has an internal haze due to scattering of the fine particle in addition to a haze due to the uneven surface structure. The internal haze causes scattering of an exterior light within the anti-glare layer, whereby a screen image substantially washes out (or is tinged with white or whitens) even in a black display (or a black state), and a light-room contrast is deteriorated. In particular, in the television (TV) application, the recent home theater boom serves as a tail wind desired for a contrasty projected image in which black appears more sharply.

Japanese Patent Application Laid-Open No. 27920/1995 (JP-7-27920A (claims 1 and 3, and paragraph numbers [0001] and [0020])) discloses a polyethylene terephthalate film for attaching to a polarizing plate which is used for a surface of various displays such as word processors, computers and televisions, particularly liquid crystal displays. The polyethylene terephthalate film is antiglare-treated by patterning with a pre-patterned film having a finely uneven structure on a surface thereof. This document describes that the anti-glare layer having a finely uneven structure on a surface thereof is obtained by coating an ionizing radiation-curable resin composition on the polyethylene terephthalate film, laminating a patterned matt film having a finely uneven structure on a surface thereof on the coated resin composition in the uncured state, irradiating ionizing radiation on the laminated matter to completely cure the coat, and separating the patterned matt film from the completely cured coat.

In a method using such a patterned film, since it is difficult to produce such a matt patterned film itself, the anti-glare film is not suitable for mass production. Further, it has been also known that such an artificial regular arrangement to the surface of the anti-glare layer unescapably brings about interference of the reflected light, and then induces moire (formation of a rainbow pattern).

Japanese Patent Application Laid-Open No. 126495/2004 (JP-2004-126495A (claims 1 and 21, and paragraph number [0090])) discloses an anti-glare film comprising at least an anti-glare layer, in which the anti-glare layer has an uneven structure on a surface thereof, and the anti-glare film isotropically transmits and scatters an incident light to show the maximum value of the scattered light intensity at a scattering angle of 0.1 to 100, and has a total light transmittance of 70 to 100%. This document describes that in a process which comprises preparing a solution of at least one polymer and at least one curable resin precursor uniformly dissolved in a solvent and evaporating the solvent from the solution to produce a sheet, spinodal decomposition under an appropriate condition, followed by curing the precursor to ensure a phase-separation structure having regularity and an uneven surface structure depending on the phase-separation structure and attachment of such an anti-glare layer having a regular phase-separation structure to a display apparatus ensures a clear image quality without blur of characters and concurrently realizes good anti-glare effects without washing out or whitening (white blur). Further, this document mentions that attachment of the film to a high-definition display apparatus effectively eliminates dazzle on the display surface and ensures high-performance anti-glaring function.

However, in the anti-glare film, as light passes through a surface of a liquid crystal panel, an ITO electrode of a constituent picture element of the liquid crystal panel or a wiring electrode of a TFT element sends part of the light back to the surface by reflecting the light. A blue light of the reflected light is partially absorbed by the ITO electrode or the wiring electrode, and as a result the surface becomes yellowish. Moreover, also in the process, it is difficult to produce an anti-glare sheet stably because it is difficult to control phase separability and a slight variation of a lot number of material, a polymer formulation and other factors remarkably changes the size of the phase-separation structure.

### SUMMARY OF THE INVENTION

It is therefore an object of the present invention to provide an anti-glare film that inhibits reflection of an exterior light or dazzle and allows a black image (an image having a high light-room contrast) to be displayed even under an exterior light; and a display apparatus comprising (or equipped with) the anti-glare film.

It is another object of the present invention to provide an anti-glare film that allows an image to be displayed at a high front contrast and a high front luminance, and makes a reflected image neutral color tone; and a display apparatus comprising (or equipped with) the anti-glare film.

The inventors of the present invention made intensive studies to achieve the above objects and finally found that use of an anti-glare layer on which a layer having a low refraction index (hereinafter, sometimes referred to as a low-refraction-index layer) is laminated inhibits reflection and allows a black image (an image having a high light-room contrast) to be displayed even under an exterior light. The anti-glare layer has an uneven surface structure formed by the use of a self-ordering phenomenon of a polymer solution (cellular rotating convection phenomenon and phase-separation phenomenon) and has a minimized internal haze. The present invention was accomplished based on the above findings.

That is, the anti-glare film of the present invention comprises an anti-glare layer, and a low-refraction-index layer formed on at least one surface of the anti-glare layer and comprising a resin having a low refraction index (hereinafter, sometimes referred to as a low-refraction-index resin) and a hollow silica particle. The anti-glare film has an internal haze of 0 to 1%, a haze (or a total haze) of 5 to 6.5%, a transmitted image clarity of 20 to 30%, and a reflected light on the film has a* of 0.5 to 1.3 and b* of −2.3 to −0.5. The hollow silica particle may have a mean particle diameter of about 50 to 70 nm and a refraction index of about 1.2 to 1.25. The low-refraction-index layer may have a refraction index of about 1.35 to 1.39. The anti-glare film may have an uneven surface structure, and the average inclination angle of the uneven surface may be about 0.7 to 1°. In the surface of the anti-glare film, the mean distance between two adjacent projections of the uneven surface structure is, for example, about 100 to 150 μm. The project may comprise a domain, and not less than one uneven part may be further formed in the domain. The low-refraction-index layer may have a thickness of about 80 to 100 nm. The anti-glare layer may comprise a plurality of polymers, the polymers may have a domain formed by a phase separation of the polymers, and a difference in refraction index between the polymers may be about 0 to 0.04.

The present invention also includes an optical member comprising a polarizing plate, and the above-mentioned anti-glare film that is laminated on at least one surface of the polarizing plate. Further, the present invention includes a liquid crystal display apparatus comprising the above-mentioned anti-glare film. The display apparatus may further comprise a prism sheet comprising a prism unit having a cross section which is an approximately isosceles triangle.

### BRIEF DESCRIPTION OF THE DRAWINGS

FIG. 1 is a schematic cross-sectional view of an optical member comprising an anti-glare film in accordance with an embodiment of the present invention and a polarizing plate laminated on the anti-glare film.

FIG. 2 is a schematic cross-sectional view of a liquid crystal panel produced in Examples.

FIG. 3 is a schematic cross-sectional view of a liquid crystal display apparatus produced in Examples.

FIG. 4 is a perspective view of a prism sheet used in Example 2 and Comparative Example 2.

FIG. 5 is a perspective view of a backlight source used in Examples.

FIG. 6 is a view illustrating a viewing angle in measurements of a front luminance and a contrast.

FIG. 7 is a laser reflection microphotograph (5 magnifications) of an uneven surface of an anti-glare film obtained in Example 1.

FIG. 8 is a graph illustrating a front luminance distribution in each of Example 1 and Comparative Example 1.

FIG. 9 is a graph illustrating a front luminance distribution in each of Example 2 and Comparative Example 2.

FIG. 10 is a graph illustrating a contrast distribution in each of Example 2 and Comparative Example 2.

### DETAILED DESCRIPTION OF THE INVENTION

[Anti-Glare Film]

The anti-glare film of the present invention comprises an anti-glare layer and a low-refraction-index layer. The low-refraction-index layer is formed on at least one surface of the anti-glare layer and comprises a low-refraction-index resin and a hollow silica particle. The anti-glare film usually comprises the anti-glare layer formed on a support, and the low-refraction-index layer is formed on the anti-glare layer.

(Support)

As the support, there may be used a support having light transmittance properties, for example, a transparent support such as a synthetic resin film. Moreover, the support having light transmittance properties may comprise a transparent polymer film for forming an optical member.

As the transparent support (or substrate sheet), there may be exemplified a resin sheet in addition to glass and ceramics. As a resin constituting the transparent support, the resin similar to that of the anti-glare layer as described later may be used. The preferred transparent support includes a transparent polymer film, for example, a film formed from a cellulose derivative [e.g., a cellulose acetate such as a cellulose triacetate (TAC) or a cellulose diacetate], a polyester-series resin [e.g., a polyethylene terephthalate (PET), a polybutylene terephthalate (PBT), and a polyarylate-series resin], a polysulfone-series resin [e.g., a polysulfone and a polyether sulfone (PES)], a polyether ketone-series resin [e.g., a polyether ketone (PEK) and a polyether ether ketone (PEEK)], a polycarbonate-series resin (PC), a polyolefinic resin (e.g., a polyethylene and a polypropylene), a cyclic polyolefinic resin (e.g., ARTON and ZEONEX), a halogen-containing resin (e.g., a polyvinylidene chloride), a (meth)acrylic resin, a styrenic resin (e.g., a polystyrene), a vinyl acetate- or vinyl alcohol-series resin (e.g., a polyvinyl alcohol) and others. The transparent support may be stretched monoaxially or biaxially, and the transparent support having optical isotropy is preferred. The preferred transparent support is a support sheet or film having a low birefringence index. The optically isotropic transparent support may include a non-stretched sheet or film, for example, a sheet or film formed from a polyester (e.g., a PET and a PBT), a cellulose ester, in particular a cellulose acetate (e.g., a cellulose acetate such as a cellulose diacetate or a cellulose triacetate, a cellulose acetate C₃₋₄acylate such as a cellulose acetate propionate or a cellulose acetate butyrate) or the like. The thickness of the support having a two-dimensional structure may be selected within the range of, for example, about 5 to 2000 μm, preferably about 15 to 1000 μm, and more preferably about 20 to 500 μm.

(Anti-Glare Layer)

The anti-glare layer comprises a polymer. In particular, in the present invention, a polymer and a curable resin precursor may be used in combination for improving abrasion resistance. In such a case, the anti-glare layer may comprise a cured product of at least one polymer and at least one curable resin precursor. The anti-glare layer produced by such a process provides the film with a regular or periodic uneven surface by curing the curable resin.

(1) Polymer Component

As a polymer component, a thermoplastic resin is usually employed. As the thermoplastic resin, there may be exemplified a styrenic resin, a (meth)acrylic resin, an organic acid vinyl ester-series resin, a vinyl ether-series resin, a halogen-containing resin, an olefinic resin (including an alicyclic olefinic resin), a polycarbonate-series resin, a polyester-series resin, a polyamide-series resin, a thermoplastic polyurethane resin, a polysulfone-series resin (e.g., a polyether sulfone and a polysulfone), a polyphenylene ether-series resin (e.g., a polymer of 2,6-xylenol), a cellulose derivative (e.g., a cellulose ester, a cellulose carbamate, and a cellulose ether), a silicone resin (e.g., a polydimethylsiloxane and a polymethylphenylsiloxane), a rubber or elastomer (e.g., a diene-series rubber such as a polybutadiene or a polyisoprene, a styrene-butadiene copolymer, an acrylonitrile-butadiene copolymer, an acrylic rubber, a urethane rubber, and a silicone rubber), and the like. These thermoplastic resins may be used singly or in combination.

The styrenic resin may include a homo- or copolymer of a styrenic monomer (e.g. a polystyrene, a styrene-α-methylstyrene copolymer, and a styrene-vinyl toluene copolymer), and a copolymer of a styrenic monomer and other polymerizable monomer [e.g., a (meth)acrylic monomer, maleic anhydride, a maleimide-series monomer, and a diene]. The styrenic copolymer may include, for example, a styrene-acrylonitrile copolymer (AS resin), a copolymer of styrene and a (meth)acrylic monomer [e.g., a styrene-methyl methacrylate copolymer, a styrene-methyl methacrylate-(meth)acrylate copolymer, and a styrene-methylmethacrylate-(meth)acrylic acid copolymer], and a styrene-maleic anhydride copolymer. The preferred styrenic resin includes a polystyrene, a copolymer of styrene and a (meth)acrylic monomer [e.g., a copolymer comprising styrene and methyl methacrylate as main units, such as a styrene-methyl methacrylate copolymer], an AS resin, a styrene-butadiene copolymer, and the like.

As the (meth)acrylic resin, a homo- or copolymer of a (meth)acrylic monomer and a copolymer of a (meth) acrylic monomer and a copolymerizable monomer may be employed. As the (meth)acrylic monomer, there may be mentioned, for example, (meth)acrylic acid; a C₁₋₁₀alkyl (meth)acrylate such as methyl (meth)acrylate, ethyl (meth)acrylate, butyl (meth)acrylate, t-butyl (meth)acrylate, isobutyl (meth)acrylate, hexyl (meth)acrylate, octyl (meth)acrylate or 2-ethylhexyl (meth)acrylate; an aryl (meth)acrylate such as phenyl (meth)acrylate; a hydroxyalkyl (meth)acrylate such as hydroxyethyl (meth)acrylate or hydroxypropyl (meth)acrylate; glycidyl (meth)acrylate; an N,N-dialkylaminoalkyl (meth)acrylate; (meth)acrylonitrile; a (meth)acrylate having an alicyclic hydrocarbon group such as tricyclodecane. The copolymerizable monomer may include the above styrenic monomer, a vinyl ester-series monomer, maleic anhydride, maleic acid, and fumaric acid. These monomers may be used singly or in combination.

As the (meth)acrylic resin, there may be mentioned, for example, a poly(meth)acrylate such as a poly(methyl methacrylate), a methyl methacrylate-(meth)acrylic acid copolymer, a methylmethacrylate-(meth)acrylate copolymer, a methyl methacrylate-acrylate-(meth)acrylic acid copolymer, and a (meth)acrylate-styrene copolymer (MS resin). The preferred (meth)acrylic resin includes a methyl methacrylate-series resin containing a poly(C₁₋₆alkyl (meth)acrylate) such as a poly(methyl (meth)acrylate), particularly methyl methacrylate as a main component (about 50 to 100% by weight, and preferably about 70 to 100% by weight).

As the organic acid vinyl ester-series resin, there may be mentioned a homo- or copolymer of a vinyl ester-series monomer (e.g., a polyvinyl acetate and a polyvinyl propionate), a copolymer of a vinyl ester-series monomer and a copolymerizable monomer (e.g., an ethylene-vinyl acetate copolymer, a vinyl acetate-vinyl chloride copolymer, and a vinyl acetate-(meth)acrylate copolymer), or a derivative thereof. The derivative of the vinyl ester-series resin may include a polyvinyl alcohol, an ethylene-vinyl alcohol copolymer, a polyvinyl acetal resin, and the like.

As the vinyl ether-series resin, a homo- or copolymer of a vinyl C₁₋₁₀alkyl ether such as vinyl methyl ether, vinyl ethyl ether, vinyl propyl ether or vinyl t-butyl ether, and a copolymer of a vinyl C₁₋₁₀alkyl ether and a copolymerizable monomer (e.g., a vinyl alkyl ether-maleic anhydride copolymer).

The halogen-containing resin may include a polyvinyl chloride, a polyvinylidene fluoride, a vinyl chloride-vinyl acetate copolymer, a vinyl chloride-(meth)acrylate copolymer, a vinylidene chloride-(meth)acrylate copolymer, and the like.

The olefinic resin may include, for example, an olefinic homopolymer such as a polyethylene or a polypropylene, and a copolymer such as an ethylene-vinyl acetate copolymer, an ethylene-vinyl alcohol copolymer, an ethylene-(meth)acrylic acid copolymer or an ethylene-(meth)acrylate copolymer. As the alicyclic olefinic resin, there may be mentioned a homo- or copolymer of a cyclic olefin such as norbornene or dicyclopentadiene (e.g., a polymer having an alicyclic hydrocarbon group such as tricyclodecane which is sterically rigid), a copolymer of the cyclic olefin and a copolymerizable monomer (e.g., an ethylene-norbornene copolymer and a propylene-norbornene copolymer). The alicyclic olefinic resin is available as, for example, the trade name “ARTON”, the trade name “ZEONEX” and the like.

The polycarbonate-series resin may include an aromatic polycarbonate based on a bisphenol (e.g., bisphenol A), an aliphatic polycarbonate such as diethylene glycol bisallyl carbonate, and others.

The polyester-series resin may include an aromatic polyester obtainable from an aromatic dicarboxylic acid such as terephthalic acid [for example, a homopolyester, e.g., a polyC₂₋₄alkylene terephthalate such as a polyethylene terephthalate or a polybutylene terephthalate, a polyC₂₋₄alkylene naphthalate, and a copolyester comprising a C₂₋₄alkylene arylate unit (a C₂₋₄alkylene terephthalate unit and/or a C₂₋₄alkylene naphthalate unit) as a main component (e.g., not less than 50% by weight)]. The copolyester may include a copolyester in which, in constituting units of a polyC₂₋₄alkylene arylate, part of C₂₋₄alkylene glycols is substituted with a polyoxyC₂₋₄alkylene glycol, a C₆₋₁₀alkylene glycol, an alicyclic diol (e.g., cyclohexane dimethanol and hydrogenated bisphenol A), a diol having an aromatic ring (e.g., 9,9-bis(4-(2-hydroxyethoxy)phenyl)fluorene having a fluorenone side chain, a bisphenol A, and a bisphenol A-alkylene oxide adduct) or the like, and a copolyester in which, in constituting units, part of aromatic dicarboxylic acids is substituted with an unsymmetric aromatic dicarboxylic acid such as phthalic acid or isophthalic acid, an aliphatic C₆₋₁₂dicarboxylic acid such as adipic acid, or the like. The polyester-series resin may also include a polyarylate-series resin, an aliphatic polyester obtainable from an aliphatic dicarboxylic acid such as adipic acid, and a homo- or copolymer of a lactone such as ε-caprolactone. The preferred polyester-series resin is usually a non-crystalline resin, such as a non-crystalline copolyester (e.g., a C₂₋₄alkylene arylate-series copolyester).

The polyamide-series resin may include an aliphatic polyamide such as a polyamide 46, a polyamide 6, a polyamide 66, a polyamide 610, a polyamide 612, a polyamide 11 or a polyamide 12, and a polyamide obtainable from a dicarboxylic acid (e.g., terephthalic acid, isophthalic acid, and adipic acid) and a diamine (e.g., hexamethylenediamine and metaxylylenediamine). The polyamide-series resin may be a homo- or copolymer of a lactam such as ε-caprolactam and is not limited to a homopolyamide but may be a copolyamide.

Among the cellulose derivatives, the cellulose ester may include, for example, an aliphatic organic acid ester of a cellulose (e.g., a C₁₋₆organic acid ester of a cellulose such as a cellulose acetate (e.g., a cellulose diacetate and a cellulose triacetate), a cellulose propionate, a cellulose butyrate, a cellulose acetate propionate, or a cellulose acetate butyrate), an aromatic organic acid ester of a cellulose (e.g. a C₇₋₁₂aromatic carboxylic acid ester of a cellulose such as a cellulose phthalate or a cellulose benzoate), an inorganic acid ester of a cellulose (e.g., a cellulose phosphate and a cellulose sulfate) and may be a mixed acid ester of a cellulose such as a cellulose acetate nitrate. The cellulose derivative may also include a cellulose carbamate (e.g. a cellulose phenylcarbamate), a cellulose ether (e.g., a cyanoethylcellulose; a hydroxyC₂₋₄alkyl cellulose such as a hydroxyethyl cellulose or a hydroxypropyl cellulose; a C₁₋₆alkyl cellulose such as a methyl cellulose or an ethyl cellulose; a carboxymethyl cellulose or a salt thereof, a benzyl cellulose, and an acetyl alkyl cellulose).

The preferred thermoplastic resin includes, for example, a styrenic resin, a (meth)acrylic resin, a vinyl acetate-series resin, a vinyl ether-series resin, a halogen-containing resin, an alicyclic olefinic resin, a polycarbonate-series resin, a polyester-series resin, a polyamide-series resin, a cellulose derivative, a silicone-series resin, and a rubber or elastomer, and the like. As the thermoplastic resin, there is usually employed a resin that is non-crystalline and is soluble in an organic solvent (particularly a common solvent for dissolving a plurality of polymers and curable compounds). In particular, a resin that is excellent in moldability or film-forming (film-formable) properties, transparency, and weather resistance [for example, a styrenic resin, a (meth)acrylic resin, an alicyclic olefinic resin, a polyester-series resin, and a cellulose derivative (e.g., a cellulose ester)] is preferred. In particular, in the present invention, the cellulose derivative is preferred as the thermoplastic resin. Since the cellulose derivative is a semisynthetic polymer and is different in dissolution behavior from other resin or a curable resin precursor, the cellulose derivative has very good phase separability.

As the polymer (or thermoplastic resin), there may be also used a polymer having a functional group participating (or being involved) in a curing reaction (or a functional group capable of reacting with the curable precursor). Such a polymer may have the functional group in a main chain thereof or in a side chain thereof. The functional group may be introduced into a main chain of the polymer with co-polymerization, co-condensation or the like and is usually introduced into a side chain of the polymer. Such a functional group may include a condensable or a reactive functional group (for example, a hydroxyl group, an acid anhydride group, a carboxyl group, an amino or an imino group, an epoxy group, a glycidyl group, and an isocyanate group), a polymerizable functional group [for example, a C₂₋₆alkenyl group such as vinyl, propenyl, isopropenyl, butenyl or allyl, a C₂₋₆alkynyl group such as ethynyl, propynyl or butynyl, a C₂₋₆alkenylidene group such as vinylidene, or a functional group having the polymerizable functional group(s) (e.g., (meth)acryloyl group)], and others. Among these functional groups, the polymerizable functional group is preferred.

The thermoplastic resin having a polymerizable group in a side chain thereof, for example, may be produced by allowing to react (i) a thermoplastic resin having a reactive group (e.g., a group similar to the functional group exemplified in the paragraph of the condensable or reactive functional group) with (ii) a compound (polymerizable compound) having a group (reactive group) reactive to the reactive group of the thermoplastic resin and a polymerizable functional group to introduce the polymerizable functional group of the compound (II) into the thermoplastic resin.

Examples of the thermoplastic resin (i) having the reactive group may include a thermoplastic resin having a carboxyl group or an acid anhydride group thereof [for example, a (meth)acrylic resin (e.g., a (meth)acrylic acid-(meth)acrylate copolymer such as a methyl methacrylate-(meth)acrylic acid copolymer, and a methyl methacrylate-acrylate-(meth)acrylic acid copolymer), a polyester-series resin or polyamide-series resin having a terminal carboxyl group], a thermoplastic resin having a hydroxyl group [for example, a (meth)acrylic resin (e.g., a (meth)acrylate-hydroxyalkyl (meth)acrylate copolymer), a polyester-series resin or a polyurethane-series resin having a terminal hydroxyl group, a cellulose derivative (e.g., a hydroxyC₂₋₄alkyl cellulose such as a hydroxyethyl cellulose or a hydroxypropylcellulose), a polyamide-series resin (e.g., an N-methylolacrylamide copolymer)], a thermoplastic resin having an amino group (e.g., a polyamide-series resin having a terminal amino group), and a thermoplastic resin having an epoxy group [e.g., a (meth)acrylic resin or polyester-series resin having an epoxy group (such as a glycidyl group)]. Moreover, as the thermoplastic resin (i) having the reactive group, there may be used a resin obtained by introducing the reactive group into a thermoplastic resin (such as a styrenic resin or an olefinic resin, and an alicyclic olefinic resin) with co-polymerization or graft polymerization. Among these thermoplastic resins (i), a thermoplastic resin having a carboxyl group or an acid anhydride group thereof, a hydroxyl group or a glycidyl group (particularly a carboxyl group or an acid anhydride group thereof) as a reactive group, is preferred. Incidentally, among the (meth)acrylic resins, the copolymer preferably contains (meth)acrylic acid in a proportion of not less than 50 mol %. These thermoplastic resins (i) may be used singly or in combination.

The reactive group of the polymerizable compound (II) may include a group reactive to the reactive group of the thermoplastic resin (i), for example, may include a functional group similar to the condensable or reactive functional group exemplified in the paragraph of the functional group of the polymer mentioned above.

Examples of the polymerizable compound (II) may include a polymerizable compound having an epoxy group [e.g., an epoxy group-containing (meth)acrylate (an epoxyC₃₋₈alkyl (meth)acrylate such as glycidyl (meth)acrylate or 1,2-epoxybutyl (meth)acrylate; an epoxycycloC₅₋₈alkenyl (meth)acrylate such as epoxycyclohexenyl (meth)acrylate), and allyl glycidyl ether], a compound having a hydroxyl group [for example, a hydroxyl group-containing (meth)acrylate, e.g., a hydroxyC₂₋₄alkyl (meth)acrylate such as hydroxypropyl (meth)acrylate; a C₂₋₆alkylene glycol mono(meth)acrylate such as ethylene glycol mono(meth)acrylate], a polymerizable compound having an amino group [e.g., an amino group-containing (meth)acrylate (such as a C₃₋₆alkenylamine such as allylamine); an aminostyrene such as 4-aminostyrene or diaminostyrene], a polymerizable compound having an isocyanate group [e.g., a (poly) urethane (meth)acrylate, or vinylisocyanate], and a polymerizable compound having a carboxyl group or an acid anhydride group thereof [e.g., an unsaturated carboxylic acid or an anhydride thereof, such as (meth)acrylic acid or maleic anhydride]. These polymerizable compounds (ii) may be used singly or in combination.

Incidentally, the combination of the reactive group of the thermoplastic resin (i) with the reactive group of the polymerizable compound (II) may include, for example, the following combinations.

(i-1) the reactive group of the thermoplastic resin (i): carboxyl group or acid anhydride group thereof,

the reactive group of the polymerizable compound (II): epoxy group, hydroxyl group, amino group, isocyanate group;

(i-2) the reactive group of the thermoplastic resin (i): hydroxyl group,

the reactive group of the polymerizable compound (II): carboxyl group or acid anhydride group thereof, isocyanate group;

(i-3) the reactive group of the thermoplastic resin (i): amino group,

the reactive group of the polymerizable compound (II): carboxyl group or acid anhydride group thereof, epoxy group, isocyanate group; and

(i-4) the reactive group of the thermoplastic resin (i): epoxy group,

the reactive group of the polymerizable compound (II): carboxyl group or acid anhydride group thereof, amino group.

Among the polymerizable compounds (II), an epoxy group-containing polymerizable compound (such as an epoxy group-containing (meth)acrylate) is particularly preferred.

The functional group-containing polymer, e.g., a polymer in which a polymerizable unsaturated group is introduced into part of carboxyl groups in a (meth)acrylic resin, is available, for example, as “CYCLOMER-P” from Daicel Chemical Industries, Ltd. Incidentally, “CYCLOMER-P” is a (meth)acrylic polymer in which epoxy group(s) of 3,4-epoxycyclohexenylmethyl acrylate is allowed to react with part of carboxyl groups in a (meth)acrylic acid-(meth)acrylate copolymer for introducing photo-polymerizable unsaturated group(s) into the side chain.

The amount of the functional group (particularly the polymerizable group) that participates in (or being involved in) a curing reaction and is introduced into the thermoplastic resin, is about 0.001 to 10 mol, preferably about 0.01 to 5 mol and more preferably about 0.02 to 3 mol relative to 1 kg of the thermoplastic resin.

The glass transition temperature of the polymer may be selected within the range of, for example, about −100° C. to 250° C., preferably about −50° C. to 230° C., and more preferably about 0° C. to 200° C. (for example, about 50° C. to 180° C.).

It is advantageous from the viewpoint of surface hardness that the glass transition temperature is not lower than 50° C. (e.g., about 70° C. to 200° C.) and preferably not lower than 100° C. (e.g., about 100° C. to 170° C.). The weight-average molecular weight of the polymer may be selected within the range of, for example, not more than 1,000,000, and preferably about 1,000 to 500,000.

These polymers may be used in combination from the viewpoint of refraction index. That is, the polymer may comprise a plurality of polymers. The plurality of polymers may be capable of phase separation from each other (in the absence of a solvent), or may be capable of phase separation in a liquid phase before complete evaporation of a solvent. Moreover, the plurality of polymers may be incompatible with each other. In the case of using in combination of a plurality of polymers, the combination use of a first polymer with a second polymer is not particularly limited to a specific one, and a plurality of polymers incompatible with each other in the neighborhood of a processing temperature, for example, two polymers incompatible with each other, may be used in a suitable combination. The difference in refraction index of the plurality of polymers (the first polymer and the second polymer) may be about 0 to 0.06, for example, about 0 to 0.04 (e.g., about 0.0001 to 0.04), and preferably about 0.001 to 0.03. Too large difference in refraction index between these polymers causes a large difference in refraction index between phase-separated domains formed within the anti-glare layer. As a result, the anti-glare layer easily generates an internal haze, and the advantages of the present invention are reduced.

In the case of using in combination of the plurality of polymers, at least a cellulose derivative may be used. The cellulose derivative may include, particularly, a cellulose ester (for example, a cellulose C₂₋₄aliphatic carboxylic acid ester such as a cellulose diacetate, a cellulose triacetate, a cellulose acetate propionate or a cellulose acetate butyrate). For example, in the case where the first polymer is a cellulose derivative (e.g., a cellulose ester such as a cellulose acetate propionate), the second polymer may be a (meth)acrylic resin, an alicyclic olefinic resin (e.g., a polymer obtained by using norbornene as a monomer), or a polyester-series resin (e.g., the above-mentioned polyC₂₋₄alkylene arylate-series copolyester). In particular, among these resins, the preferred resin includes a polymer having neither of unsaturated bond, aromatic ring, nor halogen atom.

The ratio (weight ratio) of the first polymer relative to the second polymer [the former/the latter] may be selected within the range of, for example, about 1/99 to 99/1, preferably about 5/95 to 95/5 and more preferably about 10/90 to 90/10, and is usually about 20/80 to 80/20, particularly about 30/70 to 70/30. In particular, in the case of using a cellulose derivative as the first polymer, the ratio (weight ratio) of the first polymer relative to the second polymer [the former/the latter] is, for example, about 1/99 to 30/70, preferably about 5/95 to 28/72, and more preferably about 10/90 to 27/73 (particularly, about 15/85 to 25/75).

Incidentally, the polymer formable a phase-separation structure may comprise the thermoplastic resin or other polymer(s) in addition to the above-mentioned two polymers incompatible with each other.

An uneven surface of the anti-glare layer is finally cured by an actinic ray (e.g., an ultraviolet ray, and an electron beam), heat (a thermic ray), or others so that a cured resin is formed. Accordingly, such a cured resin can impart abrasion resistance (hardcoat property) to the anti-glare film and can improve durability of the anti-glare film.

From the viewpoint of abrasion resistance after curing, at least one of the plurality of polymers, e.g., one of polymers incompatible with each other (in the case of using a first resin with a second resin in combination, particularly both polymers) is preferably a polymer having a functional group that is reactive to the curable resin precursor, in a side chain thereof.

(2) Curable Resin Precursor

As the curable resin precursor, there may be used various curable compounds having a relative functional group to heat or an actinic ray (e.g., an ultraviolet ray, and an electron beam) and being capable of forming a resin (particularly a cured or a crosslinked resin) by curing or crosslinking with heat or an actinic ray.

For example, as the resin precursor, there may be mentioned a thermosetting compound or resin [a low molecular weight compound (or prepolymer such as a low molecular weight resin (e.g., an epoxy-series resin, an unsaturated polyester-series resin, a urethane-series resin, and a silicone-series resin)) having an epoxy group, an isocyanate group, an alkoxysilyl group, a silanol group, a polymerizable group (such as vinyl group, allyl group, or (meth)acryloyl group), or others], and a photo-curable compound that is curable with an actinic ray (such as ultraviolet ray) (e.g., an ultraviolet-curable compound such as a photo-curable monomer, oligomer, or prepolymer).

The photo-curable compound may be an EB (electron beam)-curable compound, or others. Incidentally, a photo-curable compound such as a photo-curable monomer, a photo-curable oligomer, or a photo-curable resin which may have low molecular weight is sometimes simply referred to as “photo-curable resin”. These curable resin precursors may be used singly or in combination.

The photo-curable compound usually has a photo-curable group, for example, a polymerizable group (e.g., vinyl group, allyl group, (meth)acryloyl group) or a photosensitive group (e.g., cinnamoyl group). In particular, the preferred compound includes a photo-curable compound having a polymerizable group [e.g., a monomer, an oligomer (or resin, particularly a low molecular weight resin)]. These photo-curable compounds may be used singly or in combination.

Among the photo-curable compounds having a polymerizable group, as the monomer, for example, there may be exemplified a monofunctional monomer [for example, a (meth)acrylic monomer such as a (meth)acrylic ester, e.g., an alkyl (meth)acrylate (e.g., a C₁₋₂₄alkyl (meth)acrylate such as methyl (meth)acrylate, ethyl (meth)acrylate, butyl (meth)acrylate, isobutyl (meth)acrylate, 2-ethylhexyl (meth)acrylate, isodecyl (meth)acrylate, n-lauryl (meth)acrylate or n-stearyl (meth)acrylate), a cycloalkyl (meth)acrylate, a (meth)acrylate having a crosslinked cyclic hydrocarbon group (e.g., isobornyl (meth)acrylate and adamantyl (meth)acrylate), glycidyl (meth)acrylate; a fluorine-containing alkyl (meth)acrylate such as perfluorooctylethyl (meth)acrylate or trifluoroethyl (meth)acrylate; a vinyl-series monomer such as a vinyl ester (e.g., vinyl acetate) or vinylpyrrolidone], a polyfunctional monomer having at least two polymerizable unsaturated bonds [for example, an alkylene glycol di(meth)acrylate such as ethylene glycol di(meth)acrylate, propylene glycol di(meth)acrylate, butanediol di(meth)acrylate, neopentyl glycol di(meth)acrylate, or hexanediol di(meth)acrylate; a (poly)alkylene glycol di(meth)acrylate such as diethylene glycol di(meth)acrylate, dipropylene glycol di(meth)acrylate, or a polyoxytetramethylene glycol di(meth)acrylate; a di(meth)acrylate having a crosslinked cyclic hydrocarbon group (e.g., tricyclodecane dimethanol di(meth)acrylate and adamantane di(meth)acrylate); and a polyfunctional monomer having about 3 to 6 polymerizable unsaturated bonds (e.g., trimethylol propane tri(meth)acrylate, trimethylol ethane tri(meth)acrylate, ditrimethylol propane tetra(meth)acrylate, pentaerythritol tri(meth)acrylate, pentaerythritol tetra(meth)acrylate, dipentaerythritol penta(meth)acrylate, and dipentaerythritol hexa(meth)acrylate)].

Among the photo-curable compounds having a polymerizable group, examples of the oligomer or resin may include a (meth)acrylate of a bisphenol A added with an alkylene oxide, an epoxy (meth)acrylate (e.g., a bisphenol A-based epoxy (meth)acrylate, and a novolak-based epoxy (meth)acrylate), a polyester (meth)acrylate (e.g., an aliphatic polyester-based (meth)acrylate and an aromatic polyester-based (meth)acrylate), a (poly)urethane (meth)acrylate (e.g., a polyester-based urethane (meth)acrylate and a polyether-based urethane (meth)acrylate), a silicone (meth)acrylate, and others. As a hybrid photo-curable compound, for example, a trade name “OPSTAR” (manufactured by JSR Corporation) has been put on the market.

The preferred curable resin precursor includes a photo-curable compound curable in a short time, for example, an ultraviolet-curable compound (e.g., a monomer, an oligomer, and a resin which may have a low molecular weight) and an EB-curable compound. In particular, a resin precursor having a practical advantage is an ultraviolet-curable monomer or an ultraviolet-curable resin. Further, to improve resistance such as abrasion resistance, the photo-curable resin is preferably a compound having polymerizable unsaturated bonds of not less than 2 (preferably about 2 to 6, and more preferably about 2 to 4) in the molecule.

The molecular weight of the curable resin precursor is, allowing for compatibility to the polymer, not more than about 5000 (e.g., about 100 to 5000), preferably not more than about 2000 (e.g., about 150 to 2000), and more preferably not more than about 1000 (e.g., about 200 to 1000).

The curable resin precursor may be used in combination with a curing agent depending on a variety of the curable resin precursor. For example, a thermosetting resin precursor may be used in combination with a curing agent such as an amine or a polyfunctional carboxylic acid (or a polycarboxylic acid), or a photo-curable resin precursor may be used in combination with a photopolymerization initiator.

As the photopolymerization initiator, there may be exemplified a conventional component, e.g., an acetophenone, a propiophenone, a benzyl, a benzoin, a benzophenone, a thioxanthone, an acylphosphine oxide, and others.

The content of the curing agent (such as a photo-curing agent) relative to 100 parts by weight of the curable resin precursor is about 0.1 to 20 parts by weight, preferably about 0.5 to 10 parts by weight, and more preferably about 1 to 8 parts by weight (particularly about 1 to 5 parts by weight) and may be about 3 to 8 parts by weight.

Further, the curable resin precursor may contain a curing accelerator, a crosslinking agent, a thermal-polymerization inhibitor, and others. For example, the photo-curable resin precursor may be used in combination with a photo-curing accelerator, e.g., a tertiary amine (e.g., a dialkylaminobenzoic ester) or a phosphine-series photopolymerization accelerator.

In the present invention, among at least one polymer and at least one curable resin precursor, at least two components are preferably used in such a combination that these components are phase-separated with each other in the neighborhood of a processing temperature. As such a combination, for example, there may be mentioned (a) a combination in which a plurality of polymers are incompatible with each other and form a phase separation, (b) a combination in which a polymer and a curable resin precursor are incompatible with each other and form a phase separation, (c) a combination in which a plurality of curable resin precursors are incompatible with each other and form a phase separation, and other combinations. Among these combinations, (a) the combination of a plurality of polymers or (b) the combination of a polymer with a curable resin precursor is usually employed, and (a) the combination of a plurality of polymers is particularly preferred. In the case where both components to be phase-separated have high compatibility, both components fail to generate effective phase separation during a drying step for evaporating the solvent, and as a result the layer obtained therefrom deteriorates functions as an anti-glare layer.

Moreover, the above-mentioned combination may be a combination of two thermoplastic resins incompatible with each other and a curable compound (in particular a monomer or an oligomer having a plurality of curable functional groups). Further, from the viewpoint of abrasion resistance after curing, one polymer of the above-mentioned incompatible thermoplastic resins (particularly both polymers) may be a thermoplastic resin having a functional group participating in a curing reaction (a functional group participating in curing of the curable resin precursor).

In the case where the polymer comprises a plurality of polymers incompatible with each other to form phase separation, it is preferred that the curable resin precursor be compatible with at least one polymer in the neighborhood of a processing temperature, among a plurality of polymers incompatible with each other. That is, when a plurality of polymers incompatible with each other comprise, for example, a first polymer and a second polymer, it is sufficient that the curable resin precursor is compatible with at least one resin of the first polymer and the second polymer, or the curable resin precursor may be compatible with both polymer components. In the case where the curable resin precursor is compatible with both polymer components, at least two phases which are phase-separated may be obtained, one phase comprises a mixture containing the first polymer and the curable resin precursor as main components, and the other phase comprises a mixture containing the second polymer and the curable resin precursor as main components.

The curable monomer and a plurality of polymers incompatible with each other are used in such a combination that at least one polymer and the curable monomer are compatible with each other in the neighborhood of a processing temperature. That is, when a plurality of polymers incompatible with each other comprise, for example, a polymer A and a polymer B, it is sufficient that the curable monomer is compatible with at least one of the polymer A and the polymer B, or the curable monomer may be preferably compatible with both polymer components. In the case where the curable monomer is compatible with both polymer components, at least two phases which are phase-separated are obtained, one phase comprises a mixture containing the polymer A and the curable monomer as main components and the other phase comprises a mixture containing the polymer B and the curable monomer as main components.

Incidentally, each of the phase separability among a plurality of polymers and the phase separability among the polymer and the curable monomer can be judged conveniently by visually conforming whether the residual solid content becomes clouded or not during a step of preparing a uniform solution with a good solvent to both components and gradually evaporating the solvent.

Further, the polymer and a cured or crosslinked resin obtained by curing the resin precursor are usually different from each other in refraction index. Moreover, the plurality of polymers (the first polymer and the second polymer) is also different from each other in refraction index. In the present invention, the difference in refraction index between the polymer and the cured or crosslinked resin, or the difference in refraction index between the plurality of polymers (the first polymer and the second polymer) may be, for example, about 0 to 0.06, preferably about 0.00001 to 0.05, and more preferably about 0.001 to 0.04. The selection of the polymers having such a difference in refraction index enables phase-separated domains to have such a difference in refraction index.

With the progress of the phase separation, the bicontinuous structure is formed. In further proceeding the phase separation, the continuous phase becomes discontinuous owing to its own surface tension to change (or transform) into the droplet phase structure (e.g., an islands-in-the-sea structure containing independent phases such as ball-like shape, spherical shape, discotic shape, oval-sphere shape or rectangular prism shape). Therefore, an intermediate structure of the bicontinuous phase structure and the drop phase structure (i.e., a phase structure in a transitional state from the bicontinuous phase to the drop phase) can also be formed by varying the degree of phase separation. The phase-separation structure in the anti-glare layer in the present invention may be an islands-in-the-sea structure (a droplet phase structure or a phase structure in which one phase is separated or isolated) or a bicontinuous phase structure (or a mesh structure), or may be an intermediate structure being a coexistent state of a bicontinuous phase structure and a droplet phase structure. The phase-separation structure (domain) can be seen when the cross section of the film is observed by a transmission electron microscope.

Thus in the anti-glare layer having an uneven surface formed by phase separation, a difference in refraction index between materials constituting the anti-glare layer (the plurality of polymers and the cured product of the curable resin precursor) can be adjusted within the above-mentioned range. Accordingly, the anti-glare layer substantially contains no scattering medium that causes scattering in the interior of the layer, unlike an anti-glare layer obtained by a method that comprises dispersing a fine particle to form an uneven surface. Therefore, the haze in the interior of the layer (the internal haze leading to scattering in the interior of the layer) is low, for example, may be about 0 to 1%, preferably about 0 to 0.8% (e.g., about 0.01 to 0.8%), and more preferably about 0 to 0.5% (e.g., 0.1 to 0.5%). Incidentally, the internal haze can be determined by pasting a smooth transparent film on the uneven surface of the anti-glare layer through a transparent adhesive layer and measuring a haze of the planarized matter.

The ratio (weight ratio) of the polymer relative to the curable resin precursor is not particularly limited to a specific one, and for example, the polymer/the curable resin precursor may be selected within the range of about 5/95 to 95/5. From the viewpoint of surface hardness, the ratio (weight ratio) is preferably about 5/95 to 60/40, more preferably about 10/90 to 50/50, and particularly about 10/90 to 40/60. In particular, in the case of using a cellulose derivative in whole or part of the polymer, the ratio (weight ratio) of the polymer relative to the curable resin precursor [the former/the latter] is, for example, about 10/90 to 80/20, preferably about 20/80 to 70/30, and more preferably about 30/70 to 50/50.

The thickness of the anti-glare layer may be, for example, about 0.3 to 20 μm, preferably about 1 to 18 μm (e.g., about 3 to 16 μm), and usually about 5 to 15 μm (particularly about 7 to 13 μm).

(Low-Refraction-Index Layer)

In the present invention, by laminating the low-refraction-index layer on at least one side of the anti-glare layer, it can be effectively inhibited that an external light (e.g., an exterior light source) is reflected on the surface of the anti-glare film when the low-refraction-index layer is disposed so that the layer becomes the top layer in a display apparatus such as a liquid crystal display apparatus.

The low-refraction-index layer comprises a hollow silica particle and a low-refraction-index resin. In the present invention, the hollow silica particle means a silica particle having a cavity inside thereof.

The shape of the whole silica particle is not particularly limited to a specific one. For example, the shape may include a spherical shape, an ellipsoidal shape, and an amorphous shape. Among these shapes, the silica particle usually has a spherical shape.

The shape and size of the cavity are not particularly limited to a specific one as far as the refraction index of the particle is within the after-mentioned range.

The hollow silica particle may usually comprise one cavity as a core and an outer shell (or a shell) thereof. In the case of a spherical particle, the particle may have one spherical cavity. The hollow silica particle may have a plurality of cavities (e.g., cavities having a spherical shape or an ellipsoidal shape) therein. Such a hollow silica particle is described in Japanese Patent Application Laid-Open Nos. 233611/2001 (JP-2001-233611A), 192994/2003 (JP-2003-192994A), and others. The hollow silica particles as described in these documents are a colloidal particle having a low refraction index, and are excellent in dispersibility. In the present invention, the hollow silica particles as described in these documents may be preferably used, and the particles may be produced by production processes as described in these documents.

The mean particle diameter of the hollow silica particle is, for example, about 50 to 70 nm, and more preferably about 55 to 65 nm. In the case where the mean particle diameter of the hollow silica particle is too small, the refraction index of the low-refraction-index layer increases following an increase of the refraction index of the particle. Therefore, the silica particle causes lowering of light-room contrast, as a result, the screen image is liable to be whitish. On the other hand, too large mean particle diameter of the hollow silica particle sometimes causes unnecessary roughness (or unevenness) on the surface of the low-refraction-index layer because of the particle diameter close to the thickness of the layer. Such a rough (or uneven) surface sometimes causes undesired light scattering.

The refraction index (n) of the hollow silica particle is, for example, about 1.2 to 1.25, and preferably about 1.21 to 1.24. Too low refraction index of the particle deteriorates productivity of the low-refraction-index layer. Too high refraction index of the particle makes that of the low-refraction-index layer higher, and deteriorates light-room contrast. As a result, the screen image is liable to be whitish.

These hollow silica particles may be surface-treated with a silane coupling agent.

Examples of the silane coupling agent may include an alkoxysilyl group-containing silane coupling agent (e.g., a tetraC₁₋₄alkoxysilane such as tetramethoxysilane or tetraethoxysilane, a C₁₋₁₂alkyltriC₁₋₄alkoxysilane such as methyltrimethoxysilane, octyltriethoxysilane, a diC₂₋₄alkyldiC₁₋₄alkoxysilane such as dimethyldimethoxysilane, and an arylC₁₋₄alkoxysilane such as phenyltrimethoxysilane or diphenyldimethoxysilane), a halogen-containing silane coupling agent [e.g., a trifluoroC₂₋₄alkyldiC₁₋₄alkoxysilane such as trifluoropropyltrimethoxysilane, a perfluoroalkylC₂₋₄alkyldiC₁₋₄alkoxysilane such as perfluorooctylethyltrimethoxysilane, a chloroC₂₋₄alkyltriC₁₋₄alkoxysilane such as 2-chloroethyltrimethoxysilane, and a C₁₋₄alkyltrichlorosilane such as methyltrichlorosilane], a vinyl group-containing silane coupling agent (e.g., a vinyltriC₁₋₄alkoxysilane such as vinyltrimethoxysilane), an ethylenic unsaturated bond group-containing silane coupling agent [e.g., a (meth)acryloxyC₂₋₄alkylC₁₋₄alkoxysilane such as 2-(meth)acryloxyethyltrimethoxysilane or 3-(meth)acryloxypropylmethyldimethoxysilane], an epoxy group-containing silane coupling agent [e.g., a C₂₋₄alkyltriC₁₋₄alkoxysilane having an alicyclic epoxy group such as 2-(3,4-epoxycyclohexyl)ethyltrimethoxysilane, a glycidyloxyC₂₋₄alkyltriC₁₋₄alkoxysilane such as 2-glycidyloxyethyltrimethoxysilane, and 3-(2-glycidyloxyethoxy)propyltrimethoxysilane], an amino group-containing silane coupling agent [e.g., a aminoC₂₋₄alkylC₁₋₄alkoxysilane such as 2-aminoethyltrimethoxysilane or 3-aminopropylmethyldimethoxysilane, 3-[N-(2-aminoethyl)amino]propyltrimethoxysilane, N-phenyl-3-aminopropyltrimethoxysilane, and 3-ureidoisopropylpropyltriethoxysilane], a mercapto group-containing silane coupling agent (e.g., a mercaptoC₂₋₄alkyltriC₁₋₄alkoxysilane such as 3-mercaptopropyltrimethoxysilane), a carboxyl group-containing silane coupling agent (e.g., a carboxyC₂₋₄alkyltriC₁₋₁₄alkoxysilane such as 2-carboxyethyltrimethoxysilane), and a silanol group-containing silane coupling agent (e.g., trimethylsilanol). These silane coupling agents may be used singly or in combination.

As a surface-treatment method, a conventional method (e.g., methods as described in the above-mentioned JP-2001-233611A or JP-2003-192994A) may be utilized. The utilizable method include a method that comprises adding a coupling agent such as a silane coupling agent to a dispersion of the hollow silica particle (e.g., an alcohol dispersion), and further adding water to the dispersion, and adding a hydrolysis catalyst such as an acid or an alkali thereto according to need.

The refraction index (n) of the low-refraction-index resin is, for example, about 1.4 to 1.55, and preferably about 1.42 to 1.53.

The low-refraction-index resin is not particularly limited to a specific one as far as the refraction index is within the above-mentioned range. As the resin, a conventional one may be used. In the present invention, the low-refraction-index resin preferably includes an acrylic resin and/or a silicone resin.

(Acrylic Resin)

The acrylic resin may include, for example, a polyfunctional (meth)acrylate [e.g., pentaerythritol tri- or tetra(meth)acrylate, dipentaerythritol penta- or hexa(meth)acrylate, trimethylolpropane tri(meth)acrylate, trimethylolethane tri(meth)acrylate, ditrimethylolpropane tetra(meth)acrylate, and 1,6-hexanediol (meth)acrylate], a C₁₋₂₄alkyl (meth)acrylate [e.g., methyl (meth)acrylate, ethyl (meth)acrylate, butyl (meth)acrylate, 2-ethylhexyl (meth)acrylate, n-lauryl (meth)acrylate, and n-stearyl (meth)acrylate], a fluorine-containing alkyl (meth)acrylate [e.g., perfluorooctylethyl (meth)acrylate, and trifluoroethyl (meth)acrylate], and a (poly)urethane (meth)acrylate. These acrylic resins may be used singly or in combination.

(Silicone Resin)

The silicone resin (or silicone-series resin) may include, for example, a resin obtained by simultaneous radical-polymerization or hydrolytic condensation of the acrylic resin and an organic silicon compound (a silane coupling agent), and a mixture obtained by independent radical-polymerization or hydrolytic condensation of these components. The organic silicon compound may include the above-mentioned silane coupling agent, for example, an epoxy group-containing silane coupling agent [e.g., glycidyloxymethyltrimethoxysilane, glycidyloxymethyltriethoxysilane, 2-glycidyloxyethyltrimethoxysilane, 2-glycidyloxyethyltriethoxysilane, 3-glycidyloxypropyltrimethoxysilane, 3-glycidyloxypropyltriethoxysilane, and 3-(2-glycidyloxyethoxy)propyltrimethoxysilane], and an ethylenic unsaturated bond group-containing silane coupling agent [e.g., (meth)acryloxymethyltrimethoxysilane, (meth)acryloxymethyltriethoxysilane, 2-(meth)acryloxyethyltrimethoxysilane, 2-(meth)acryloxyethyltriethoxysilane, 3-(meth)acryloxypropyltrimethoxysilane, and 3-(meth)acryloxypropyltriethoxysilane]. The proportion (weight ratio) of the acrylic monomer relative to the silane coupling agent [the former/the latter] is, for example, about 99/1 to 10/90, preferably about 97/3 to 30/70, and more preferably about 95/5 to 50/50. Further, the silicone resin may be a methyl-series silicone resin, a methylphenyl-series silicone resin, an acryl-modified silicone resin, an epoxy-modified silicone resin, and others. These silicone resins may be used singly or in combination.

Use of the acrylic resin and/or the silicone resin as the low-refraction-index resin improves dispersibility of the hollow silica particle surface-treated with the silane coupling agent in the low-refraction-index resin, and also improves affinity between the low-refraction-index resin and the hollow silica particle surface-treated with the silane coupling agent. Accordingly, use of such a resin(s) realizes a low-refraction-index layer excellent in properties such as transparency and strength.

Among these low-refraction-index resins, a silicone resin obtained by polymerizing a silicone monomer having three or more reactive groups is preferred. Such a silicone resin having a large number of reactive functional groups (bonding sites) strengthens the bonding between the low-refraction-index resin components, or that between the resin and the surface-treated hollow silica particle. Accordingly, a transparent coat excellent in strength and abrasion resistance can be formed with the use of the resin.

The low-refraction-index resin may be further used in combination with a water repellent agent. The water repellent agent is a reactive resin having two or less reactive group(s) introduced or added thereinto. Such a reactive resin may include, for example, a hydrophobic resin having a (meth)acryloyl group [e.g., a silicone resin having a (meth)acryloyl group, a fluorine-containing resin having a (meth)acryloyl group, and an olefinic resin having a (meth)acryloyl group], and a siloxane-series acrylic resin [e.g., a resin in which an acrylic resin (such as urethane (meth)acrylate) is bonded to one end of a polysiloxane]. The hydrophobic resin having a (meth)acryloyl group may be, for example, a hydrophobic resin in which a (meth)acryloyl group is added to one end of a polysiloxane or a fluorine resin. These water repellent agents may be used singly or in combination.

Such a reactive resin has a low compatibility to the low-refraction-index resin and is located in the outer layer of the transparent coat. Accordingly, use of the reactive resin provides water repellency (the property that an angle of contact of a water droplet is not smaller than 90°) on the surface of the transparent coat, resulting in preventing adhesion of stains such as fingerprint, sebum and perspiration. Moreover, even when stains are adhered to the surface, the stains can be easily removed (or wiped off).

For example, the proportion of the water repellent agent is, on a solid matter basis, about 0.1 to 10% by weight and preferably about 0.5 to 5% by weight relative to the low-refraction-index resin as a matrix. Too low proportion of the water repellent agent cannot improve water repellency as well as a stain-proofing (or an antifouling) property such as an anti-fingerprint property or a felt-pen's-ink-repellent property. On the other hand, too high proportion of the water repellent agent causes excessive exposure (or causes bleed out) of the water repellent agent on the surface of the coat, resulting in abnormal appearance (e.g., ununiformity and whitening) or tendency to lower hardness of the coat.

The low-refraction-index resin in the low-refraction-index layer may be also used in combination with a curing agent or a crosslinking agent, a polymerization initiator, a curing accelerator, and others as exemplified in the paragraph of the curable resin precursor in the anti-glare layer. In particular, the resin is preferably used in combination with an acetophenone-series, a benzoin ether-series, or a thioxanthone-series photopolymerization initiator. The proportion of the polymerization initiator such as the photopolymerization initiator is about 0.1 to 15 parts by weight, preferably about 0.5 to 10 parts by weight and more preferably about 1 to 8 parts by weight relative to 100 parts by weight of the low-refraction-index resin. Too low proportion of the polymerization initiator does not allow the polymerization to progress sometimes, even by irradiating with an actinic ray (e.g., an ultraviolet ray) after coating the resin. Too high proportion of the initiator deteriorates stability of the coating composition, thereby tending to cause whitening in the coating process.

The proportion (weight ratio) of the hollow silica particle relative to the low-refraction-index resin [the hollow silica particle/the low-refraction-index resin] is about 10/1 to 1/5, preferably about 5/1 to 1/3, and more preferably about 3/1 to 1/2 (particularly, about 2/1 to 1/1). These components having the proportion within the range strike a balance between anti-glare and film-forming (or film-formable) properties.

The refraction index (n) of the low-refraction-index layer may be selected from the range of about 1.3 to 1.4. The refraction index is, for example, about 1.35 to 1.39, and preferably 1.36 to 1.38. Too small refraction index of the low-refraction-index layer requires a higher proportion of the hollow silica particle while the light-room contrast can be improved. As a result, the layer tends to be insufficient in abrasion resistance. Too large refraction index of the layer deteriorates the light-room contrast because of an increase of the reflectance, as a result, the screen image tends to have a whitish tinge.

The thickness of the low-refraction-index layer is, for example, about 80 to 100 nm, and preferably about 85 to 95 nm. Too small thickness of the layer sometimes deviates from Fresnel's principle, and deteriorates the anti-reflective performance or the light-room contrast. As a result, the screen image is easy to have a whitish tinge. On the other hand, too large thickness of the layer also sometimes deviates from Fresnel's principle, and deteriorates the anti-reflective performance or the light-room contrast. As a result, the screen image tends to have a whitish tinge.

The component constituting such a low-refraction-index layer is available, for example, in the form of a solution (coating liquid). Such a coating liquid is obtainable, for example, as “SH-1074SIC” manufactured by Catalysts & Chemicals Industries Co., Ltd.

(Characteristics of Anti-Glare Film)

In the anti-glare film of the present invention, the anti-glare layer comprises a plurality of domains phase-separated from each other and a matrix, and has an uneven surface formed by the domains and the matrix. Moreover, the domains may be formed regularly or periodically.

That is, in the present invention, the plurality of domains on the surface of the anti-glare layer is formed at a relatively controlled interval corresponding to arrangement of convection cells formed in a production process of the anti-glare layer. In particular, the anti-glare layer has an uneven surface formed as convection cells. Such an uneven surface (domain) is a closed uneven (loop) region, and usually, it is sufficient that the loop (exterior loop) is almost closed. Moreover, almost all of the domains may be separated, or some adjacent domains may be connected with each other through a long and slender (or narrow) connection part. The shape of the domain is not particularly limited to a specific one, and is an amorphous shape, a circular form, an oval (or elliptical) form, a polygonal form, and others. The shape is usually a circular form or an oval form.

Further, usually the domain (uneven surface) formed by cellular rotating convection substantially has regularity or periodicity. The mean distance between two adjacent projections of such an uneven surface [the pitch between the tops of two adjacent projections (or between the domains)] may be selected from the range of about 50 to 200 μm. For example, the mean distance is, for example, about 100 to 150 μm, and preferably about 120 to 140 μm. The mean distance between two adjacent projections is, for example, controllable by the thickness of the coating film when convection is generated.

Furthermore, in the anti-glare film of the present invention, at least one uneven part (internal cell) may be formed within each domain in the surface. The shape of the surface of each domain may be, as observed from the direction perpendicular to the plane direction of the film, for example, a double-circle form or a circular form in which a circle forming each domain has a plurality of small circles therein. That is, the uneven part formed in each domain may be formed as a raised (or upheaved) part (minute raised region) protruded by a rising flow or a depressed part (minute depressed region) or caved by a rising flow at a position corresponding to a central part or peripheral part of the convection cell. This uneven part is also a closed loop (interior loop), and usually, the interior loop may be almost closed. Moreover, the interior loop is separated or isolated in many cases. Some adjacent loops may be connected with each other through a long and slender (or narrow) connection part. In particular, one to several (e.g., about 1 to 3) uneven part(s) (particularly punctiform raised part(s)) may be formed within one domain. The shape of the uneven part (interior loop) (the two-dimensional shape of the film surface, or the outline of the border between the interior loop and the exterior loop) is not particularly limited to a specific one and is amorphous, a circular form, an oval form, a polygonal form, and others. The shape is usually a circular form or an oval form. Incidentally, in the case where a minute uneven part is formed inside each convection cell by a rising flow or phase-separation structure, the light scattering property of the film is improved, as a result, dazzle of a reflection image can be inhibited. Further, such a formation of a minute uneven part inside each convection cell is particularly preferred since each distance between interior loops of the cells becomes more equally so that the domain forms a uniform uneven shape.

The size (diameter) of the interior loop (minute uneven part) may be, for example, about 3 to 150 μm, and is preferably about 5 to 100 μm and more preferably about 10 to 50 μm (particularly about 15 to 40 μm). The area ratio of the interior loop is about 1 to 80%, preferably about 3 to 50% and more preferably about 5 to 40% (particularly about 10 to 30%) relative to the exterior loop area.

As the surface roughness of the anti-glare film, the average inclination angle of the surface may be within the range of about 0.5 to 1.50, and may be, for example, about 0.7 to 1° and preferably about 0.8 to 0.95°. The average inclination angle may be measured in accordance with JIS (Japanese Industrial Standards) B0601 by using a contacting profiling surface texture and contour measuring instrument (manufactured by Tokyo Seimitsu Co., Ltd., trade name “surfcom570A”).

The total light transmittance of the anti-glare film of the present invention is, for example, about 70 to 100%, preferably about 80 to 99%, and more preferably about 85 to 98% (particularly, about 88 to 97%).

The haze of the anti-glare film of the present invention may be selected from the range of about 1 to 10%, and is, for example, about 5 to 6.5% and preferably about 5.5 to 6%.

The haze and the total light transmittance can be measured with a NDH-5000W haze meter manufactured by Nippon Denshoku Industries Co., Ltd. in accordance with JIS K7105.

The image clarity (transmitted image clarity) of the anti-glare film of the present invention may be selected from the range of, in the case of using an optical slit of 0.5 mm width, about 10 to 70%, and is, for example, about 20 to 30% and preferably about 25 to 30%.

The image clarity is a measure for quantifying defocusing or distortion of a light transmitted through a film. The image clarity is obtained by measuring a transmitted light from a film through a movable optical slit, and calculating an amount of light in both a light part and a dark part of the optical slit. That is, in the case where a transmitted light is blurred by a film, the slit image formed on the optical slit becomes wider, and as a result the amount of light in the transmitting part is not more than 100%. On the other hand, in the non-transmitting part, the amount of light is not less than 0% due to leakage of light. The value C of the image clarity is defined by the following formula according to the maximum value M of the transmitted light in the transparent part of the optical slit, and the minimum value m of the transmitted light in the opaque part thereof.
C(%)=[(M−m)/(M+m)]×100

That is, the more the value C approaches 100%, the less the image is defocused by the anti-glare film [reference; Suga and Mitamura, Tosou Gijutsu, July, 1985].

As an apparatus for measuring the image clarity, there may be used an image clarity measuring apparatus (ICM-1DP, manufactured by Suga Test Instruments Co., Ltd.). As the optical slit, there may be used an optical slit of 0.125 mm to 2 mm in width.

In the case where the image clarity is within the range, the outline (or contour) of reflection can be enough blurred so that excellent anti-glareness is imparted to the film. Too high image clarity deteriorates an effect on inhibition of reflection. On the other hand, too small image clarity inhibits the above-mentioned reflection but deteriorates clearness (or sharpness) of image.

The reflected light on the anti-glare film of the present invention has a* of about 0.5 to 1.3 (preferably about 0.6 to 1.25, and more preferably about 0.7 to 1.2) and b* of about −2.3 to −0.5 (preferably about −2.3 to −0.6, and more preferably about −2.25 to −0.7) as a chromaticity in a L*a*b* expression in accordance with JIS Z8701-1999 (CIE1976). That is, the reflected color of the anti-glare film surface formed on the polarizing plate preferably has a chromaticity which represents a slightly blue color. In the case where the chromaticity of the reflected light is in such a range, a reflected light of a light entered through the surface of the liquid crystal panel is partly absorbed in an ITO electrode or a wiring electrode by combination of the anti-glare film and the liquid crystal panel, whereby the reflected light is prevented from changing from blue to yellow. As a result, the reflected-light chromaticity can be neutralized.

[Process for Producing Anti-Glare Film]

The anti-glare film of the present invention may be produced, for example, through a step for producing an anti-glare layer and then a step for producing a low-refraction-index layer. The step for producing the anti-glare layer may comprise forming an anti-glare layer on a support. The step for producing the low-refraction-index layer may comprise forming a low-refraction-index layer on the anti-glare layer.

(1) Step for Producing Anti-Glare Layer

The anti-glare layer may be produced by preparing a mixture solution containing at least one polymer, at least one curable resin precursor, and a solvent, coating the solution on a support film, and generating a cellular rotating convection and a phase separation in the wet coating film in a step for drying the wet (undried) coating film. In the present invention, further, the preferred process comprises coating a solution containing a plurality of polymers capable of phase-separating from each other, at least one curable resin precursor, and a solvent having a boiling point of not lower than 100° C. on a support, generating cellular rotating convection (convection cell) and phase separation in the wet coating film in a step for drying the wet coating film, and then curing the coating film to give an anti-glare film. Incidentally, in the case of using a separable support as the support, the coating film comprising the anti-glare layer and the low-refraction-index layer may be released (or separated) from the support to give an anti-glare film.

(Cellular Rotating Convection)

In the present invention, the regular or periodic uneven surface is formed on a surface of the film by coating the solution and raising the surface of the coating film by a cellular rotating convection. In general, because of cooling near the surface of the coating film by vaporization heat which is generated as evaporating the solvent to dryness, a temperature difference between the upper and lower layers of the coating film goes beyond the criticality, as a result the rotating convection is generated. Such a convection is referred to as Benard convection. Moreover, Benard convection is discovered by Benard and theoretically systematized by Rayleigh, therefore the convection is also referred to as Benard-Rayleigh convection. The critical temperature difference (ΔT) is determined by the thickness of the coating film (d), the coefficient of kinematic viscosity of the coating film (solution) (ν), the thermal diffusibility of the coating film (κ), the coefficient of cubical expansion of the coating film (α) and the gravitational acceleration (g). The convection is generated when the Rayleigh number (Ra) defined by the following formula exceeds a certain critical value.
Ra=(α··ΔT·d³)/(κ·ν)

The generated convection regularly repeats upstroke and downstroke so that the surface of the film has a regular or periodic unevenness arranged in a cell-like form. It is known that the aspect ratio of the cell (the coated direction/the thick direction) is about 2/1 to 3/1.

Moreover, the mode of the cellular rotating convection is not particularly limited to a specific one, and may be other convection mode. For example, the mode of the cellular rotating convection may be Marangoni convection (density convection) due to inhomogeneously distributed surface tension.

(Combination of Convection and Phase Separation)

In the present invention, as mentioned above, the uneven surface is formed by generating rotating convection to give convection flow and concentration difference in solid content. Together with such convection, two components having phase separability from each other (at least two components among polymers and curable resin precursors) may be phase-separated by using a solution containing the components to form a phase-separation structure. Although the details of mechanism in combination of convection and phase separation are not yet elucidated, the mechanism can be presumed as follows.

By combining convection and phase separation, firstly convection cells a regenerated after coating. Next, phase separation is developed within each of the convection cells. The phase-separation structure grows to an enormous size with time, and the growth of the phase separation is stopped in the wall of the convection cell. As a result, an uneven pattern (or part) having a controlled interval depending on the size and arrangement of the cell and a good shape and height obtained by phase separation is formed. That is, an anti-glare film in which the shape, arrangement and size of the uneven pattern (or part) are sufficiently controlled can be obtained.

(Solvent)

In the present invention, the convection or phase separation may be conducted by evaporating the solvent from the solution containing the polymer and the curable resin precursor. In particular, among components contained in the solution, the solvent is absolutely necessary to generate convection stably. The reason is that the solvent has an action to lower a surface temperature of a coating film by vaporization heat due to evaporation and further has fluidity to allow the generated convection to flow or circulates without stagnation.

The solvent may be selected depending on the kinds and solubility of the polymer and curable resin precursor to be used. In the case of a mixed solvent, it is sufficient that at least one solvent component is a solvent for uniformly dissolving a solid content (a plurality of polymers and curable resin precursor(s), a reaction initiator, other additive(s)). As such a solvent, there may be mentioned, for example, a ketone (e.g., acetone, methyl ethyl ketone, methyl isobutyl ketone, acetylacetone, acetoacetic acid ester, and cyclohexanone), an ether (e.g., diethyl ether, dioxane, and tetrahydrofuran), an aliphatic hydrocarbon (e.g., hexane), an alicyclic hydrocarbon (e.g., cyclohexane), an aromatic hydrocarbon (e.g., toluene and xylene), a carbon halide (e.g., dichloromethane and dichloroethane), an ester (e.g., methyl acetate, ethyl acetate, and butyl acetate), water, an alcohol (e.g., methanol, ethanol, propanol, isopropanol, butanol, cyclohexanol, diacetone alcohol, furfuryl alcohol, tetrahydrofurfuryl alcohol, ethylene glycol, propylene glycol, and hexylene glycol), a cellosolve (e.g., methyl cellosolve, ethyl cellosolve, butyl cellosolve, diethylene glycol monomethyl ether, diethylene glycol monoethyl ether, and propylene glycol monomethyl ether), a cellosolve acetate, a sulfoxide (e.g., dimethyl sulfoxide), and an amide (e.g., dimethylformamide, and dimethylacetamide). These solvents may be used singly or in combination.

Incidentally, Japanese Patent Application Laid-Open No. 126495/2004 (JP-2004-126495A) discloses, the same as the present invention, a process for producing a sheet, which comprises evaporating a solvent from a solution containing at least one polymer and at least one curable resin precursor uniformly dissolved in the solvent. In the process, an anti-glare layer is produced by spinodal decomposition under an appropriate condition followed by curing the precursor. Although this document discloses a process for forming an uneven surface of the anti-glare film by phase separation due to spinodal decomposition, there is no description of cellular rotating convection.

In the present invention, in order to generate such a convection cell, as a solvent, it is preferred to use a solvent having a boiling point of not lower than 100° C. at an atmospheric pressure. Further, to generate the convection cell, the solvent preferably comprises at least two solvent components with different boiling points. Moreover, the boiling point of the solvent component having a higher boiling point may be not lower than 100° C. and is usually about 100 to 200° C., preferably about 105 to 150° C. and more preferably about 110 to 130° C. In particular, from the viewpoint of using in combination of convection cell and phase separation, the solvent preferably comprises at least one solvent component having a boiling point of not lower than 100° C. and at least one solvent component having a boiling point of lower than 100° C. in combination. In the case of using such a mixed solvent, the solvent component having a lower boiling point generates a temperature difference between the upper and lower layers of the coating film due to evaporation, and the solvent component having a higher boiling point remains in the coating film resulting in keeping of fluidity.

The solvent (or solvent component) having a boiling point of not lower than 100° C. at an atmospheric pressure may include, for example, an alcohol (e.g., a C₄₋₈alkyl alcohol such as butanol, pentyl alcohol or hexyl alcohol), an alkoxy alcohol (e.g., a C₁₋₆alkoxyC₂₋₆alkyl alcohol such as methoxypropanol or butoxyethanol), an alkylene glycol (e.g., a C₂₋₄alkylene glycol such as ethylene glycol or propylene glycol), and a ketone (e.g., cyclohexanone). These solvents may be used singly or in combination. Among them, a C₄₋₈alkyl alcohol such as butanol, a C₁₋₆alkoxyC₂₋₆alkyl alcohol such as methoxypropanol or butoxyethanol, and a C₂₋₄alkylene glycol such as ethylene glycol are preferred.

The ratio of the solvent components with different boiling points is not particularly limited to a specific one. In the case of using a solvent component having a boiling point of not lower than 100° C. (a first solvent component) in combination with a solvent component having a boiling point lower than 100° C. (a second solvent component), the ratio of the first solvent component relative to the second component (when each of the first and second solvent components comprises a plurality of components, the ratio is defined as a weight ratio of the total first solvent components relative to the total second solvent components) may be, for example, about 10/90 to 70/30, preferably about 10/90 to 50/50, and more preferably about 15/85 to 40/60 (particularly about 20/80 to 40/60).

Moreover, when a liquid mixture or coating liquid is coated on a transparent support, a solvent which does not dissolve, corrode or swell the transparent support may be selected according to the kinds of the transparent support. For example, when a triacetylcellulose film is employed as the transparent support, tetrahydrofuran, methyl ethyl ketone, isopropanol, toluene or the like is used as a solvent for the liquid mixture or the coating liquid and thus the anti-glare film can be formed without deteriorating properties of the film.

(Viscosity and Concentration of Solution)

According to the present invention, in order to maintain the shape of the uneven surface due to convection and ensure the viscosity of the solution to allow the generated convection to flow a circulate without stagnation, the solid content of the solution may be, for example, about 5 to 50% by weight, preferably about 10 to 40% by weight, and more preferably about 15 to 35% by weight.

(Coating Thickness)

In order to generate cellular rotating convection with a desired size, the coating thickness of the solution may be, for example, about 10 to 200 μm, preferably about 15 to 100 μm, and more preferably about 20 to 50 μm. With the use that the aspect ratio of the convection cell becomes 2 to 3, an uneven surface (or uneven pattern) in which the distance between adjacent projections is about 100 μm can be obtained by coating of the solution on the support at a coating thickness of about 30 to 80 μm. The thickness of the coating film becomes thin due to evaporation of part of the solvent (or solvent component) with a lower boiling point in the solution, and concurrently the evaporation generates a temperature difference between the upper and the lower layers of the coating film, as a result, cellular rotating convection having a size of about 50 μm can be generated.

(Coating Method)

The coating method may include a conventional manner, for example, a roll coater, an air knife coater, a blade coater, a rod coater, a reverse coater, a bar coater, a comma coater, a dip and squeeze coater, a die coater, a gravure coater, a microgravure coater, a silkscreen coater, a dipping method, a spraying method, and a spinner method. Among these methods, a bar coater or a gravure coater is used widely. In general, in the production of the anti-glare layer, cellular convection tends to be arranged in a machine direction (a MD direction of the film, or a moving direction of a coater such as bar coater).

(Drying Temperature)

The cellular rotating convection and phase separation is preferably induced by casting or coating the solution, and then evaporating the solvent at a temperature lower than the boiling point of the solvent [for example, at a temperature lower than a boiling point of a solvent having a higher boiling point by about 1 to 120° C. (preferably by about 5 to 80° C. and particularly by about 10 to 60° C.)]. For example, depending on the boiling point of the solvent, the coating film may be dried at a temperature of about 30 to 200° C. (e.g., about 30 to 100° C.), preferably about 40 to 120° C. and more preferably about 50 to 100° C.

Moreover, in order to generate cellular rotating convection, after casting or coating the solution on the support, instead of putting the coating film immediately in a dryer such as an oven for dryness, it is preferable that the coating film be put in a dryer after leaving the coating film for a predetermined time (e.g., for about 1 second to 1 minute, preferably about 3 to 30 seconds and more preferably about 5 to 20 seconds) at an ambient temperature or room temperature (e.g., about 0 to 40° C. and preferably about 5 to 30° C.).

Moreover, the dry air flow rate is not particularly limited to a specific one. In the case where the air flow rate is too high, the coating film is dried and solidified before enough generation of rotating convection. Accordingly, the dry air flow rate may be not higher than 50 m/minute (e.g., about 1 to 50 m/minute), preferably about 1 to 30 m/minute and more preferably about 1 to 20 m/minute. The angle of the dry wind blown against the anti-glare film is not particularly limited to a specific one. For example, the angle may be parallel or perpendicular to the film.

In particular, for generating cellular rotating convection, it is preferred to dry the coating film in the presence of a solvent, under an external force that does not inhibit formation of convection cell or an external force that does not inhibit convection in a phase separation region, for example, under a calm or a low air flow rate. That is, specifically, cellular rotating convection can be generated by heating the coating film under a calm or low air flow rate (e.g., about 0.1 to 8 m/minute, preferably about 0.5 to 6 m/minute and more preferably about 1 to 5 m/minute) in a dryer having the above-mentioned drying temperature. Incidentally, instead of drying the film under a low air flow rate, the angle of the dry wind blown against the film may be adjusted to a low angle, for example, not larger than 700, preferably about 5 to 600 and more preferably about 10 to 500. The heating time under a calm or low air flow rate may be, for example, about 1 second to 1 minute, preferably about 3 to 30 seconds and more preferably about 5 to 20 seconds (particularly about 7 to 15 seconds).

(Curing Treatment)

After drying the solution, the coating film is cured or crosslinked by a thermic ray or an actinic ray (e.g., an ultraviolet ray, and an electron beam). The curing process may be selected depending on the kinds of the curable resin precursor, and a curing process by light irradiation such as an ultraviolet ray or an electron beam is usually employed. The widely used light source for exposure is usually an ultraviolet irradiation equipment. If necessary, light irradiation may be carried out under an inert gas atmosphere.

(2) Step for Producing Low-Refraction-Index Layer

The process for forming the low-refraction-index layer is not particularly limited to a specific one, and it is sufficient that a layer comprising at least the above-mentioned resin-based material is formed on the anti-glare layer. The low-refraction-index layer may be usually formed by coating or flow casting a coating liquid containing a low-refraction-index component (e.g., a low-refraction-index resin, a hollow silica particle, and a polymerization initiator) on the anti-glare layer, and curing the coating film with a thermal source or an actinic ray.

The solvent is not particularly limited to a specific one as far as the solvent can dissolve or disperse the low-refraction-index resin or the polymerization initiator and can uniformly disperse the hollow silica particle (particularly, a surface-treated hollow silica particle). As the solvent, a solvent as exemplified in the paragraph of the anti-glare layer may be used. Further, as the solvent, a reactive diluent [e.g., a (meth)acrylic monomer such as a polyfunctional (meth)acrylate] may be contained. Such a solvent may be evaporated and removed together with formation of the coating film. In the case where the solvent is a reactive diluent, the solvent may be cured by polymerization along with curing of a curable resin precursor.

The solid content of the coating liquid is, for example, about 1 to 10% by weight, preferably about 1.5 to 8% by weight, and more preferably about 2 to 6% by weight (particularly, about 2.5 to 5% by weight). Specifically, the concentration of the hollow silica particle in the coating liquid is, for example, about 0.1 to 5% by weight, and preferably about 0.2 to 3% by weight. Too low concentration of the hollow silica particle deteriorates productivity of the film because of lowering the coatability. Too high concentration of the hollow silica particle tends to cause aggregation due to a large amount of the particle component in the coating liquid. The concentration of the low-refraction-index resin in the coating liquid is, for example, about 0.5 to 5% by weight, and preferably about 1 to 3% by weight. Too low concentration of the low-refraction-index resin has a difficulty in obtaining a layer having a sufficient thickness in the coating process, resulting in tending to lack in uniformity. Too high concentration of the resin deteriorates the coatability.

The coating method, the drying method, and the curing method may be conducted in the same manner as the case of the anti-glare layer. Incidentally, in the drying step, no adjustment is required unlike the case of the anti-glare layer. The coating liquid may be dried in a conventional manner at a predetermined temperature.

The thickness of the coating liquid (the thickness after drying) is, for example, about 0.01 to 30 μm, and preferably 0.1 to 8 μm.

[Optical Member]

The anti-glare film of the present invention has uniform and high-definition anti-glareness because of having an uneven surface in which each raised part is uniformly controlled by cellular rotating convection and phase separation and having a low-refraction-index layer containing a specific hollow silica particle as the outermost layer. Further, the anti-glare film of the present invention has a high abrasion resistance (hardcoat property) and substantially contains no scattering medium within the film. Accordingly, the anti-glare film realizes a high light-room contrast without having a whitish tinge due to an exterior light. Therefore, the anti-glare film of the present invention is suitable for application of an optical member or others, and the above-mentioned support may also comprise a transparent polymer film for forming various optical members. The anti-glare film obtained in combination with the transparent polymer film may be directly used as an optical member, or may form an optical member in combination with an optical element [for example, a variety of optical elements to be disposed into a light path, e.g., a polarizing plate, an optical retardation plate (or phase plate), and a light guide plate (or light guide)]. That is, the anti-glare film may be disposed or laminated on at least one light path surface of an optical element. For example, the anti-glare film may be laminated on at least one surface of the optical retardation plate, or may be disposed or laminated on an emerging surface (or emerge surface) of the light guide plate.

The anti-glare film having imparted abrasion resistance can be also performed as a protective film. The anti-glare film of the present invention is, therefore, suitably used for a laminate (optical member) in which the anti-glare film is used instead of at least one protective film among two protective films constituting a polarizing plate, that is, in which the anti-glare film is laminated on at least one surface of a polarizing plate.

[Display Apparatus]

The anti-glare film of the present invention can be utilized for various display apparatuses or devices such as a liquid crystal display (LCD) apparatus, a cathode ray tube display, an organic or inorganic EL display, a field emission display (FED), a surface-conduction electron-emitter display (SED), a rear projection television display, a plasma display (PDP), and a touch panel-equipped display device. These display apparatuses comprise the anti-glare film or the optical member (particularly, e.g., a laminate of a polarizing plate and an anti-glare film) as an optical element. In particular, the anti-glare film can be preferably used for a liquid crystal display apparatus and others because the anti-glare film can inhibit reflection even in the case of being attached to a large-screen liquid crystal display apparatus such as a high-definition or high-definitional liquid crystal display.

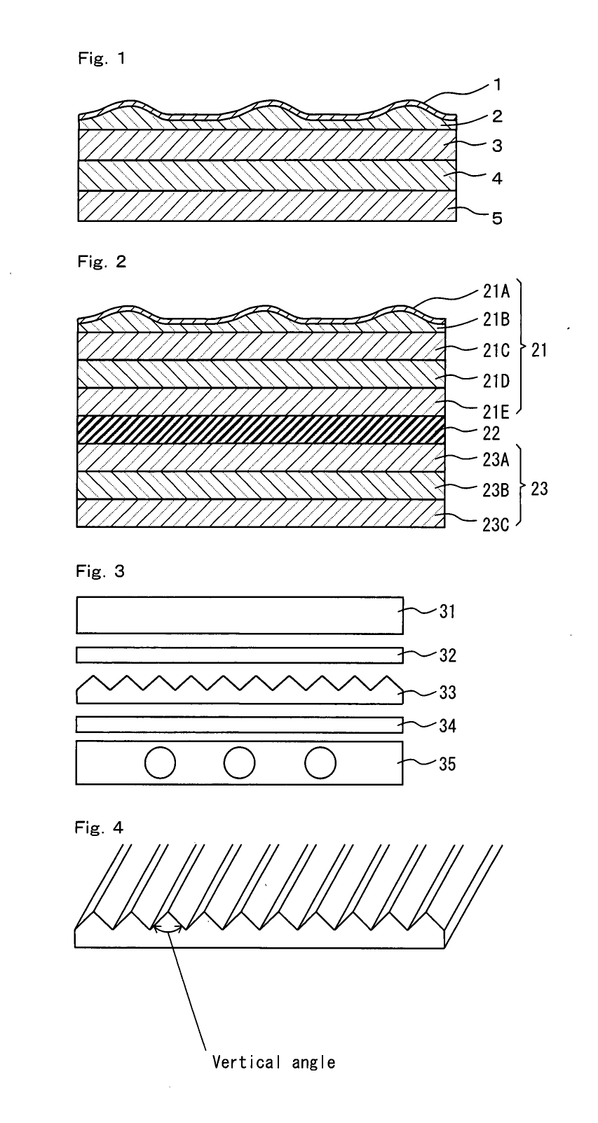

FIG. 1 is a schematic cross-sectional view of an optical member comprising an anti-glare film in accordance with an embodiment of the present invention and a polarizing plate and having a laminated structure. The optical member comprises a polarizing layer 4, an anti-glare layer 2, and a low-refraction-index layer 1 formed on the anti-glare layer 2. The polarizing layer 4 has protective layers 3 and 5 on both sides. The anti-glare layer 2 is formed on the protective layer 3. In the optical member, the polarizing layer 4 is a film obtained by drawing a polyvinyl alcohol and dyeing the drawn polyvinyl alcohol with an iodine compound or a dye. Each of the protective layers 3 and 5 comprises a transparent resin, for example, a cellulose acetate-series resin such as a triacetylcellulose, a polyester-series resin, a polycarbonate-series resin, a polysulfone-series resin, a polyarylate-series resin, an acrylic resin such as a methyl methacrylate-series resin, and a cyclic polyolefinic resin such as a norbornene resin.

Incidentally, the liquid crystal display apparatus may be a reflection-mode (or reflective) liquid crystal display apparatus using an external light (or outside light) for illuminating a display unit comprising a liquid crystal cell, or may be a transmission-mode (or transmissive) liquid crystal display apparatus comprising a backlight unit for illuminating a display unit. In the reflection-mode liquid crystal display apparatus, the display unit can be illuminated by taking in an incident light from the outside through the display unit, and reflecting the transmitted incident light by a reflective member. In the reflection-mode liquid crystal display apparatus, the anti-glare film or optical member (particularly a laminate of a polarizing plate and an anti-glare film) can be disposed in a light path in front of the reflective member. For example, the anti-glare film or optical member can be disposed or laminated, for example, between the reflective member and the display unit, or on the front surface of the display unit.

A transmissive liquid crystal display apparatus such as a liquid crystal television mainly employs a direct backlight unit. The backlight unit comprises a diffusion plate for the purpose of diffusing a light from a light source (e.g., a tubular light source such as a cold cathode tube or a hot cathode tube, and a point light source such as a light emitting diode) to make the brightness of the light uniform. Further, a prism sheet may be disposed on the front surface of the diffusion plate to increase the front luminance. The prism sheet has triangular prism units each having a cross section which is an approximately isosceles triangle, and the units are arranged in parallel with each other to form a plurality of prism lines. The prism sheet comprises a transparent resin such as an olefinic resin(e.g., acyclic olefin), a polycarbonate-series resin, or a poly(methyl methacrylate)-series resin. As the prism sheet, for example, “BEF series” manufactured by Sumitomo 3M Limited and others are commercially available. In the present invention, the prism sheet is not particularly limited to a specific one as far as the prism unit has a cross section which is an approximately isosceles triangle. The prism sheet is preferably a sheet having a sharp vertical angle of the isosceles triangle compared with a sheet having a rounded vertical angle of the isosceles triangle. Specifically, even in the case where the vertical angle is rounded, the radius of the curved surface may be, for example, not larger than 5 μm, and preferably not larger than 1 μl. The vertical angle is usually almost 90°.

Further, a reflective polarizing sheet may be disposed on the front surface of the prism sheet. The reflective polarizing sheet may be a multilayer membrane comprising a polyethylene-series resin and plays a role in the improvement of the light use efficiency. As the reflective polarizing sheet, for example, a trade name “DBEF” (manufactured by Sumitomo 3M Limited) and others have been put on the market.

In the liquid crystal display apparatus, the liquid crystal mode is not particularly limited to a specific one. For example, the liquid crystal mode may be a VA (Vertically Aligned) mode, a TN (Twisted Nematic) mode, an STN (Super Twisted Nematic) mode, an IPS mode (In-Plane Switching), and an OCB (Optical Compensated Bend) mode.

In the present invention, use of a film comprising an anti-glare layer having a specific uneven surface and a specific internal haze in combination with a low-refraction-index layer allows various displays equipped with the film to maintain anti-glareness and to display a black image (an image having a high light-room contrast) even under an exterior light. Further, combination use of the anti-glare film and a liquid crystal panel in a liquid crystal display makes a reflected light neutral color tone. Furthermore, in the liquid crystal display apparatus (the liquid crystal panel), while an image having a brightness (having a high luminance) and a high contrast is required, it has been difficult to improve 1% of luminance. In the present invention, combination use of the anti-glare film of the present invention and the prism sheet having a vertical angle of almost 900 allows remarkable improvement of not less than 10% of the luminance.

The present invention is useful for a variety of applications which require anti-glareness and light-scattering properties, e.g., for the optical member or an optical element of a display apparatus such as a liquid crystal display apparatus (in particular, a high-definition or high-definitional display apparatus). In particular, combination use of the anti-glare film and the liquid crystal panel improves the light-room contrast and realizes a neutral reflected color in a black display. Therefore, the film of the present invention is particularly suitable as an anti-glare film used for a liquid crystal display apparatus, a PDP, an organic electroluminescence (EL), and others.

### EXAMPLES

The following examples are intended to describe this invention in further detail and should by no means be interpreted as defining the scope of the invention. Each of anti-glare films obtained in above-mentioned Examples and Comparative Examples was evaluated by the following items.

[Haze]

The haze was measured by using a haze meter (manufactured by Nippon Denshoku Industries Co., Ltd., trade name “NDH-5000W”).

[Image (Transmitted Image) Clarity]

The image clarity of the anti-glare film was measured in accordance with JIS K7105 by using an image clarity measuring apparatus (manufactured by Suga Test Instruments Co., Ltd., trade name “ICM-1DD”) provided with an optical slit (the slit width=0.5 mm). The image clarity was measured in the following method: the film was installed so that the machine direction of the film was parallel to the teeth direction of the optical slit.

[Average Inclination Angle]

The average inclination angle was measured in accordance with JIS B0601 by using a contacting profiling surface texture and contour measuring instrument (manufactured by Tokyo Seimitsu Co., Ltd., trade name “surfcom570A”).

[Microphotograph of Surface Structure and Mean Distance Between Two Adjacent Projections]

A black film was bonded on the reverse side of the anti-glare film obtained in Example 1. A photograph of the uneven surface of the anti-glare film was taken by using a laser reflecting microscope. Further, based on the photograph, the mean distance between two adjacent projections (pitch) was calculated.

[Chromaticity of Reflected Color]

Concerning each of anti-glare films obtained in Examples, the chromaticity of the reflected color of L*a*b* color system (CIE 1976 (L*, a*, b*) color space, C light source, data interval: 5 nm) was measured in accordance with color matching functions defined by JIS Z8701-1999 (CIE1976). The measurement was conducted in accordance with a measuring method of total light reflection described in JIS K7105 by using a spectrophotometer (a trade name “V-560” manufactured by JASCO Corporation).

[Mounting Evaluation]

As shown in FIG. 2, a liquid crystal panel was made by bonding polarizing plates 21 and 23 on both sides of a liquid crystal cell 22, respectively, so that the absorption axes of these polarizing plates were at right angles to each other. The polarizing plate 21 comprised a low-refraction-index layer 21A, an anti-glare layer 21B, a support film (protective layer) 21C, a polarizing layer 21D, and a protective layer 21E. The anti-glare layer 21B and the low-refraction-index layer 21A were laminated on a first side of the support film 21C, and the polarizing layer 21D and the protective layer 21E were laminated on a second side of the support film 21C. The polarizing plate 23 comprised a polarizing layer 23B, and protective layers 23A and 23C. The protective layers 23A and 23C were formed on first and second sides of the polarizing layer 23B, respectively.

Incidentally, in FIG. 2, the anti-glare film obtained in Example 1 was used as an anti-glare film. On the other hand, in the case of Comparative Example 1, the anti-glare film (which utilizes internal scattering) obtained in Comparative Example 1 was used.

With the use of the liquid crystal panel, as shown in FIG. 3, a diffusion film 34, a prism sheet 33, a reflective polarizing film 32, and a liquid crystal panel 31 were arranged in this order on a backlight source 35, and a liquid crystal display apparatus comprising the liquid crystal panel and a drive circuit of a backlight was produced. That is, in the liquid crystal display apparatus, the anti-glare film of the present invention and the polarizing plate 21 were laminated on a front side of the liquid crystal panel 31, and another polarizing plate 23 was laminated on a back side of the panel 31 so that the absorption axes of the polarizing plate and the polarizing layer were at right angles to each other. In the liquid crystal display apparatus, a vertically aligned mode (VA mode) was applied as the liquid crystal mode. The liquid crystal panel of the vertically aligned mode displays a black display at the state that the in-plane phase difference is almost zero. By using such a liquid crystal display apparatus, a voltage was applied to the liquid crystal panel, and the following evaluation was made.

Incidentally, FIG. 4 shows a schematic perspective view of the prism sheet 33. In the sheet, the vertical angle of the isosceles triangle of the prism part is almost 90°. For example, a trade name “BEFIII” manufactured by Sumitomo 3M Limited corresponds to such a prism sheet, and is commercially available. On the other hand, as a prism sheet having a rounded vertical angle of the isosceles triangle, a trade name “RBEF” manufactured by Sumitomo 3M Limited is commercially available.

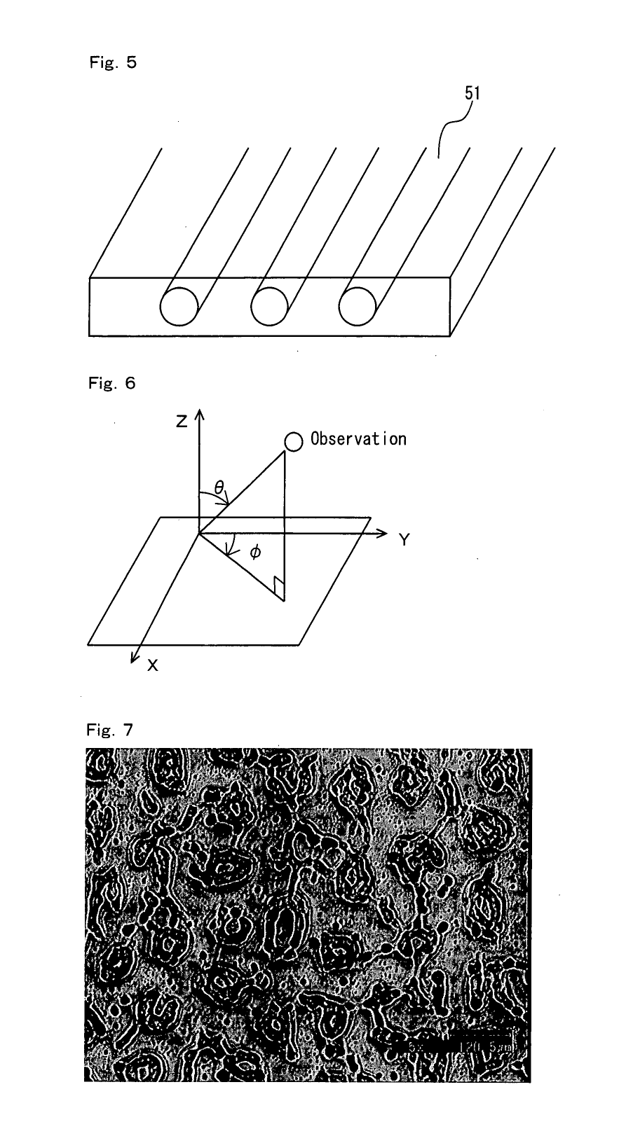

Moreover, FIG. 5 shows a schematic perspective view of the backlight source 35. This backlight source is a direct backlight unit in which tubular light sources 51 are disposed in parallel with each other.

(Front Luminance and Contrast)

A luminance of a screen image in which only a white color was displayed was measured by using a liquid crystal viewing angle and chromaticity measuring apparatus (manufactured by ELDIM, trade name “Ez-Contrast”). In the same manner, a luminance of a screen image in which a black color was displayed was measured by using the same apparatus, and “the luminance in the white state/the luminance in the black state” was determined as a contrast. In the measurement, as shown in FIG. 6, the long side of the liquid crystal unit was taken as X-axis direction, and the short side thereof was taken as Y-axis direction. The measurement was carried out with varying the viewing angle θ of the liquid crystal.

(Anti-Glareness)

A fluorescent lamp having an exposed fluorescent tube was used. The reflected light of the lamp on the panel surface was visually observed, and blurring of the reflected outline of the fluorescent tube was evaluated on the basis of the following criteria.

“A”: No reflected outline of the fluorescent lamp is observed.

“B”: The reflected outline of the fluorescent lamp is slightly observed, but it is negligible.

“C”: The reflected outline of the fluorescent lamp is observed, and it is slightly considerable.

“D”: The strongly reflected outline of the fluorescent lamp is observed, and it is very considerable.

(Darkness of Reflected Image)

An observer's face was reflected on the panel surface in a light-room environment. The reflected image was visually observed, and the darkness of the reflected image and the distinction of the facial features were evaluated on the basis of the following criteria.

“A”: The reflected image of the face is sufficiently dark, and no reflected outline of the face is observed.

“B”: The reflected image of the face is slightly observed, but the facial features cannot be distinguished.

“C”: The reflected image of the face is observed, and the facial features are distinguished.

“D”: The strongly reflected image of the face is observed, and is very considerable.

(Blackness)

The liquid crystal panel was installed so that the surface of the panel was almost perpendicular to the floor.

In a light-room environment having an illuminance of not less than 500 lux (lx) and having white walls on either side of the panel, the surface of the panel in a state of the black display was visually observed whether the surface appeared black, and evaluated on the basis of the following criteria.

“A”: The surface sufficiently appears black.

“B”: The surface appears black.

“C”: The surface does not very appear black.

“D”: The surface hardly appears black.

(Brightness of White Display)

Only a white color was displayed in the liquid crystal panel and was visually observed about the brightness, and evaluated on the basis of the following criteria.

“A”: very bright

“B”: bright

“C”: not very bright

“D”: not bright at all

### Example 1

In a mixed solvent containing 18 parts by weight of methyl ethyl ketone (MEK) (boiling point: 80° C.), 3 parts by weight of 1-butanol (BuOH) (boiling point: 113° C.) and 4.5 parts by weight of 1-methoxy-2-propanol (boiling point: 119° C.) were dissolved 5.7 parts by weight of an acrylic resin having a polymerizable unsaturated group(s) in a side chain thereof [manufactured by Daicel Chemical Industries, Ltd., “CYCLOMER-P”], 0.6 part by weight of a cellulose acetate propionate (acetylation degree=2.5%, propionylation degree=46%, number average molecular weight in terms of polystyrene: 75,000; manufactured by Eastman, Ltd., “CAP-482-20”), 4.6 parts by weight of a polyfunctional acrylic UV-curable monomer (manufactured by DAICEL-CYTEC Company, Ltd., “DPHA”), 1 part by weight of a polyfunctional acrylic UV-curable monomer (manufactured by DAICEL-CYTEC Company, Ltd., “PETIA”), 2.5 parts by weight of a polyfunctional hybrid UV-curing agent (manufactured by JSR Corporation, “Z7501”), 0.35 part by weight of a photopolymerization initiator (manufactured by Ciba Specialty Chemicals K.K., “IRGACURE 184”) and 0.15 part by weight of a photopolymerization initiator (manufactured by Ciba Specialty Chemicals K.K., “IRGACURE 907”). The mixture was used as a coating solution for an anti-glare layer. Incidentally, the cellulose acetate propionate and the acrylic resin are incompatible with each other, and the concentration of the resulting solution is accompanied by phase separability. The solution was coated on a cellulose triacetate film by a continuous mechanical coating. The coating manner was a microgravure manner. A coat layer having a thickness of about 11 μm and an uneven surface was formed by using a drying furnace that was separately controllable of a drying condition of a first zone and that of a second zone. After drying by the drying furnace, the obtained coat layer was subjected to UV curing treatment for about 30 seconds by irradiating ultraviolet rays from a metal halide lump (manufactured by Eyegraphics Co., Ltd.) to form an anti-glare film having hardcoat property and an uneven surface structure.

Further, on the anti-glare layer of the film, a coating liquid for forming a low-refraction-index layer (manufactured by Catalysts & Chemicals Industries Co., Ltd., trade name “SH-1074SIC”, which contains 1.8% by weight of a surface-treated hollow silica fine particle having a mean particle diameter of 60 nm and a refraction index (n) of 1.23, and 1.2% by weight of a UV-curable resin component), which was a UV-curable coating material containing a hollow silica, was coated by using a coating machine. The coat layer was dried at 60° C., and was subjected to UV curing treatment for about 30 seconds by irradiating ultraviolet rays from a metal halide lump (manufactured by Eyegraphics Co., Ltd.) to form a low-refraction-index layer having a thickness of about 90 nm. Thus an anti-glare film was produced. The characteristics of the obtained film are shown in Table 1. Further, the laser reflection microphotograph of the uneven surface of the film is shown in FIG. 7. The magnifying power of the objective lens was 5. As apparent from FIG. 7, it is clear that the uneven surface (exterior loop) is formed by cellular rotating convection cell and phase separation and that each projection of the uneven surface has one or several interior loop(s) (raised part(s)) formed therein. That is, it is clear that a small circle and/or a double (or more) circle is observed.

Incidentally, in the mounting evaluation of Example 1, a sheet (brand name “RBEF” manufactured by Sumitomo 3M Limited) was used as a prism sheet.

### Comparative Example 1

To 50 parts by weight of a urethane acrylate-series monomer (manufactured by Shin-nakamura Chemical Corporation, trade name “U6HA”), 8 parts by weight of a polystyrene bead having a mean particle diameter of 4 μm, and 2 parts by weight of a photopolymerization initiator (manufactured by Ciba Specialty Chemicals K.K., trade name “IRGACURE 184”) were mixed. The mixture was diluted with toluene so that the solid content was reduced by 35% by weight to prepare a particle-dispersed coating liquid. This dispersion was coated on a triacetylcellulose film having a thickness of 80 μm so that the thickness of the coat layer after drying was 7 μm. The coat layer was subjected to UV curing treatment for about 30 seconds by irradiating ultraviolet rays from a metal halide lump (manufactured by Eyegraphics Co., Ltd.) to form a film having an anti-glare layer. Thus obtained anti-glare film is an anti-glare film utilizing internal scattering. Further, a coating liquid comprising a thermosetting fluorine-containing compound (manufactured by Nissan Chemical Industries, Ltd., “LR202B”, solid content: 1% by weight) was coated on the anti-glare layer of the film with the use of a wire bar #5. The coated product was dried, and then hot-cured (or heat-cured) at 90° C. for 5 minutes to form a low-refraction-index layer having a thickness of about 78 nm, and an anti-glare film was obtained. The characteristics of the obtained film are shown in Table 1.

Incidentally, also in the mounting evaluation of Comparative Example 1, a sheet (brand name “RBEF” manufactured by Sumitomo 3M Limited) was used as a prism sheet.

TABLE 1

| | |
|---|---|
| | Comparative |
| Example 1 | Example 1 |

| Haze | 5.7% | | 46.8% | |
|---|---|---|---|---|
| Internal haze | 0.9% | | 37.8% | |
| Transmitted image clarity | 28% | | 39.1% | |
| Average inclination angle | 0.9° | | 1.1° | |
| Mean distance between two | 135 | μm | — | |
| adjacent projections | | | | |
| Thickness of | 90 | nm | 78 | nm |
| low-refraction-index layer | | | | |
| CIE 1976 (L*, a*, b*) | a* = 1.12 | | a* = 0.5 | |
| color space | b* = −2.22 | | b* = −0.12 | |
| Front luminance | 420 | cd/m² | 420 | cd/m² |

| | | |
|---|---|---|
| Brightness of white display | B | B |
| Contrast (dark-room) | 620 | 600 |
| Anti-glareness | B | B |
| Darkness of reflected image | A | C |
| Blackness of display | A | D |
| (light-room) | | |

As apparent from the results of Table 1, the anti-glare film of Example 1 has a high contrast in a light-room and a dark-room, and a high anti-glareness. In particular, the black display in which the reflected color of the liquid crystal panel is neutral is realized. On the contrary, the anti-glare film of Comparative Example 1 has a low contrast in a light-room environment.

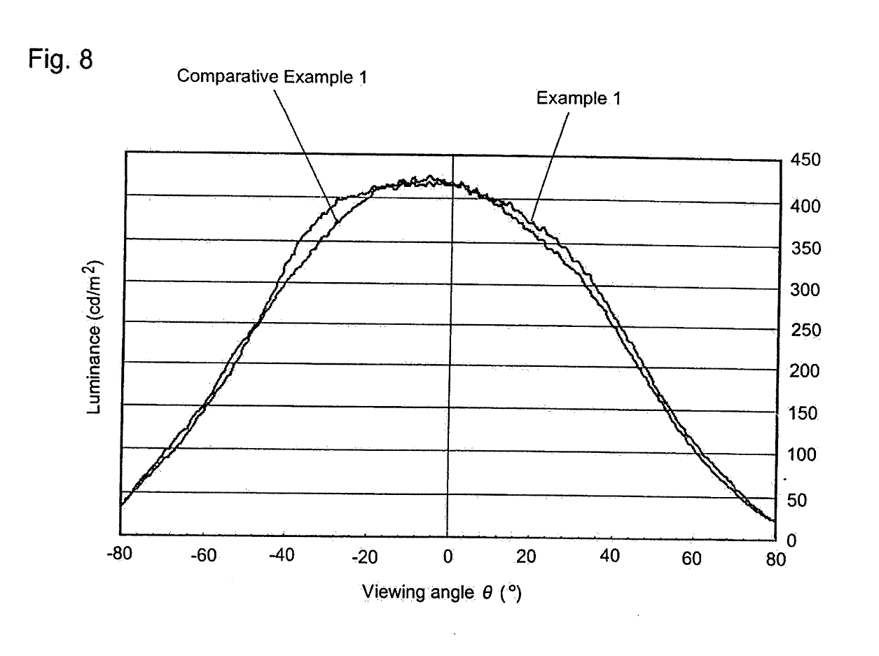

Incidentally, FIG. 8 represents a graph illustrating a front luminance distribution in each of the anti-glare films of Example 1 and Comparative Example 1.

### Example 2

In the mounting evaluation, the characteristics of the film was measured or evaluated in the same manner as Example 1 except that a sheet (manufactured by Sumitomo 3M Limited, trade name “BEFIII”) was used as a prism sheet. The results are shown in Table 2.

### Comparative Example 2

In the mounting evaluation, the characteristics of the film was measured or evaluated in the same manner as Comparative Example 1 except that a sheet (manufactured by Sumitomo 3M Limited, trade name “BEFIII”) was used as a prism sheet. The results are shown in Table 2.

TABLE 2

| | | Comparative |
|---|---|---|
| | Example 2 | Example 2 |
| Front luminance | 450 cd/m² | 400 cd/m² |
| Brightness of white display | A | B |
| Contrast (dark-room) | 660 | 600 |
| Anti-glareness | B | B |
| Darkness of reflected image | A | C |
| Blackness of display | A | D |
| (light-room) | | |

In Example 1 and Comparative Example 1, there was no difference in front luminance. In Example 2, the front luminance is improved and up about 10% compared with Comparative Example 2, and the contrast is also improved and up about 10% compared with Comparative Example 2.

That is, in Example 1, due to the sheet having a rounded vertical angle disposed as a prism sheet, in the case where a light from the light source is concentrated in the front direction, an emitted light toward the front direction is diffused or scattered around the front direction in some degree. Therefore, it is surmised that the advantage of the low haze is prevented and the front luminance cannot be improved even in the case of the liquid crystal panel in which the anti-glare film having a low haze of the present invention is disposed on a surface thereof.

On the contrary, in Example 2, due to the sheet having a vertical angle of almost 90° disposed as a prism sheet, an emitted light toward the front direction is concentrated in a narrow area. Therefore, in the liquid crystal panel, the anti-glare film having a low haze of the present invention is disposed on a surface thereof, and it is surmised that a scattering light is decreased and the front luminance is improved.

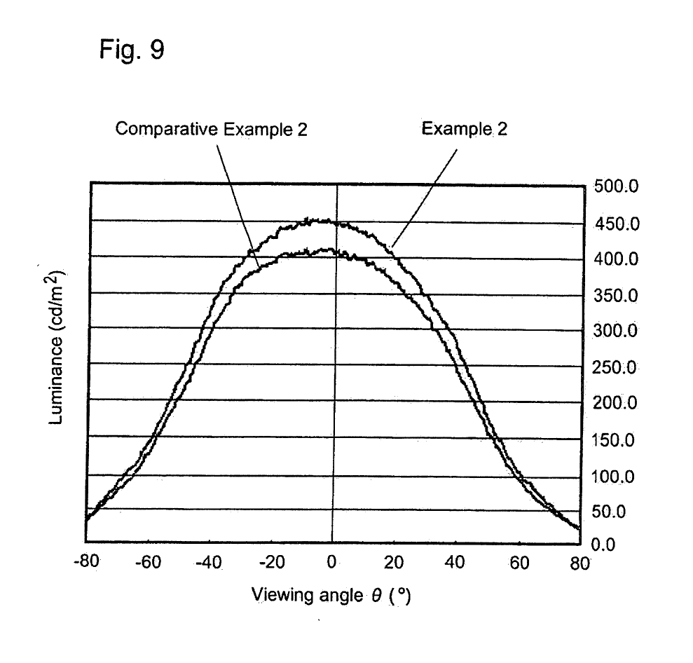

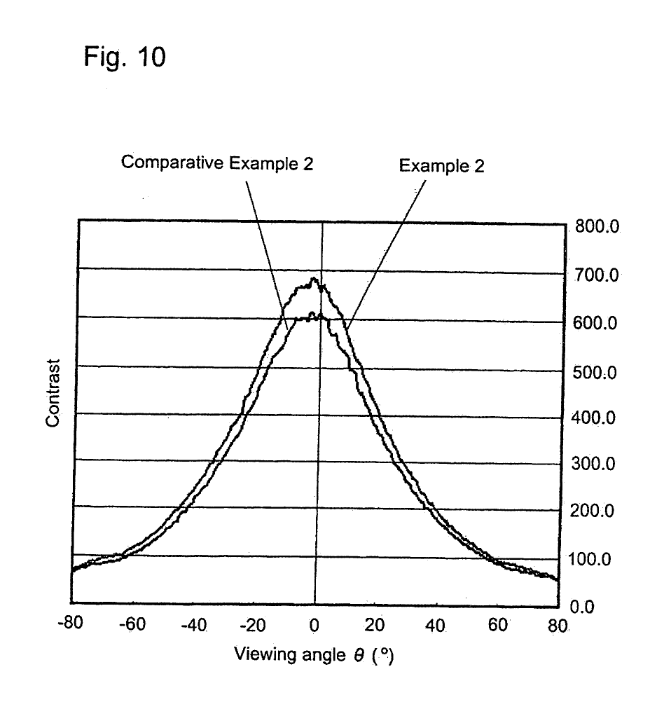

Incidentally, concerning Example 2 and Comparative Example 2, FIG. 9 shows a graph illustrating a front luminance distribution, and FIG. 10 shows a graph illustrating a contrast distribution.

What is claimed is:

1. An anti-glare film comprising:
an anti-glare layer, and
a low-refraction-index layer formed on at least one surface of the anti-glare layer and comprising a resin having a low refraction index and a hollow silica particle,
wherein the anti-glare film has an internal haze of 0 to 1%, a haze of 5 to 6.5%, a transmitted image clarity of 20 to 30%, and a reflected light on the film has a* of 0.5 to 1.3 and b* of −2.3 to −0.5.

2. An anti-glare film according to claim 1, wherein the hollow silica particle has a mean particle diameter of 50 to 70 nm and a refraction index of 1.2 to 1.25, and the low-refraction-index layer has a refraction index of 1.35 to 1.39.

3. An anti-glare film according to claim 1, which has an uneven surface structure and the average inclination angle of the uneven surface is 0.7 to 1°.

4. An anti-glare film according to claim 3, wherein the mean distance between two adjacent projections of the uneven surface structure is 100 to 150 nm.

5. An anti-glare film according to claim 4, wherein the projection comprises a domain, and not less than one uneven part is further formed in the domain.

6. An anti-glare film according to claim 1, wherein the layer having a low refraction index has a thickness of 80 to 100 nm.

7. An anti-glare film according to claim 1, wherein the anti-glare layer comprises a plurality of polymers and has a domain formed by a phase separation of the polymers, and a difference in refraction index between the polymers is 0 to 0.04.

8. An optical member comprising
a polarizing plate, and
an anti-glare film recited in claim 1,
wherein the anti-glare film is laminated on at least one surface of the polarizing plate.

9. A liquid crystal display apparatus comprising an anti-glare film recited in claim 1.

10. A liquid crystal display apparatus according to claim 9, which further comprises a prism sheet comprising a prism unit having a cross section which is an approximately isosceles triangle.
